(19) United States
(12) Patent Application Publication
(10) Pub. No.: US 2001/0002412 A1
(43) Pub. Date: May 31, 2001

(54) DECORATIVE STRUCTURALLY ENHANCED IMPREGNATED POROUS STONE PRODUCT

(76) Inventor: JOHN P. KOLARIK, HERKIMER, NY (US)

Correspondence Address: CHRISTOPHER R. PASTEL, BROWN, PINNISI AND MICHAELS PC, 400 M&T BANK BUILDING-118 NORTH TIOGA ST, ITHACA, NY, 14850

(21) Appl. No.: 08/964,800

(22) Filed: Nov. 6, 1997

Related U.S. Application Data
(60) Provisional application No. 60/029,944, filed on Nov. 7, 1996.

(51) Int. Cl. E02D 3/00; E02D 3/12; C09K 7/00; C08K 9/00; C08K 9/10; C08K 9/12; C08K 9/06; C08L 1/00; C08J 3/00; C08K 3/34

(52) U.S. Cl. 523/210; 523/130; 523/131; 523/177; 523/204; 523/207; 523/209; 523/211; 523/212; 524/442; 524/443; 524/444; 524/445; 524/448; 524/449; 524/450; 524/451; 524/452

(57) ABSTRACT

An easily shaped evacuated porous stonelike body is impregnated in a consistent manner with a fluid polymer forming composition or molten polymer composition and solidified to form a polymeric matrix stone product bearing a striking resemblance to a natural rock in texture, structure, and formation exhibited throughout any substantial cross section. The polymeric composition is decoratively enhanced by the labyrinthic skeletal framework of the porous body and the skeletal framework is structurally enhanced by the polymeric composition. The method of forming the product closely duplicates the natural formation of most of the rocks exposed at the surface of the earth. Therefore, a wide range of stonelike textures are now available in a dimensional stock product of pre-determined size and shape. A wide range of chemical and physical properties are also possible depending upon the specific combination of porous bodies and solidified polymeric compositions. A solid surface article with an impregnated and solidified synthetic resin matrix is provided for a wide range of ornamental and architectural uses.

### BACKGROUND OF INVENTION

This invention relates to polymer impregnated, previously formed, natural or artificial stones; and particularly to compositions that resemble natural rocks in texture, structure, and formation; and specifically to a dimensional stock polymer impregnated stone composite structure product, a method for forming a polymeric matrix stone product, and a solid surface synthetic resin impregnated stone article capable of a wide range of surface textures and suitable for ornamental and architectural use.

### BACKGROUND—RELATED PRIOR ART

There has long been a need for a decorative material that resembles a natural rock material throughout, but is easier to form to shape, is structurally reinforced throughout, and is lighter in weight than the majority of commercial natural stone products. This is evidenced by great number of products designed to create a stone look.

Most of the solid or porous rocks existing in nature are formed by impregnating or embedding a previously formed structure with a fluid. The fluid may be in the form of a solution that subsequently precipitates a cement of varying thickness within a previously formed structure. The fluid may also be an inorganic gel solidifying within a previously formed structure. It may be a fluid magma cooling between an earlier formed crystalline structure, or cooling within voids, cracks, and fissures which the magma has pentrated or impregnated. The fluid may be a gas penetrating the structure of a cooling magma. Most all natural rocks have varying degrees of solidified minerals surrounding a previously formed rock or mineral framework structure.

No prior art artificial stone represents a consistent polymeric fluid solidified throughout the evacuated continuous permeable interstitial spaces of a porous stonelike body in order to form a wide range of artificial composites representing a wide range of natural rocks in texture, structure, and formation that can be easily produced as substitutes for decorative natural stone.

In the past, most decorative polymer matrix artificial stones included particulate matter distributed throughout the matrix to resemble natural rock or mineral markings and structures. Using various sizes and shapes of particles and implementing various steps of distributing the particles throughout the polymeric matrix has produced a only limited representation of the structure and formation of most natural rocks. Only a limited variety of natural rocks are formed in this concreted mixture manner.

In the past, there have been methods of impregnating porous stonelike bodies for the purpose of preserving and/or strengthening the structure of the porous body. However, methods of impregnating a porous stonelike body so that the framework of the porous body provides a decorative effect to the solidified impregnant have been ignored as a method of forming a polymer impregnated stone product.

### OBJECTS AND ADVANTAGES

Accordingly, several objects and advantages of this invention are: to provide a new use for natural and artificial stonelike porous bodies as a bulk filler for defining the size, external shape, and texture of a polymeric matrix stone product; to provide a polymer impregnated pre-formed porous stone product with the advantage that the impregnated polymer component is decoratively enhanced by the porous body framework and the porous body framework is structurally enhanced by the polymer component; to provide a multiple use polymer impregnated stone composite structure dimensional stock product resembling a natural product in texture, structure, and formation exhibited throughout any substantial cross section in a manner simulative of a wide range of natural rock textures, structures, and formations; and to provide a multiple use ornamental and architectural solid surface article with an internal synthetic resin impregnated stone composite structure and an external surface further capable of representing a wide range of external stone textures advantageously similar to a wide range of natural rock surface textures.

There are vast natural resources of natural porous rock that currently are of limited use. Distributing and solidifying a fluid polymeric impregnant within a pre-formed natural stone magnifies their use and increases their economic value. Also, artificial porous stonelike bodies can now be designed to resemble a wide range of natural rock frameworks prior to impregnation with a polymeric matrix. This advantage overcomes the limitations of particulate matter distribution within a polymeric matrix. The main bulk filler cannot settle out, and also can be prearranged in virtually any configuration both internally and externally. In both natural and artificial porous bodies, the new use of embedding a single porous filler of pre-determined configuration within a matrix is provided as an advantageous alternative to mixing a multiple particulate filler within a polymer composition matrix. As such this invention includes a method of forming a polymeric matrix stone product as a result of the configuration of the main bulk filler in lieu of distributing a particulate filler throughout a polymeric matrix.

A highly decorative and structurally enhanced polymer impregnated pre-formed stone product is created by using the principles of forced fluid flow to distribute a relatively low viscosity synthetic or natural polymer composition, or polymer forming composition throughout most of the evacuated permeable interstitial spaces of a pre-formed porous stone or porous body.

When a fluid polymer composition solidifies within and upon a pre-formed porous stone or porous body, the overall physical appearance and the bulk physical properties of the resultant product are dramatically different than that of each individual component prior to this combination. The penetration and interfingering of the component solidified polymer composition is relatively substantial, and is relatively consistent throughout any particular substantial cross section of the polymer impregnated stone product.

The polymer or polymer composition component is decoratively enhanced by the porous stonelike skeletal framework. The porous stonelike skeletal framework component is structurally enhanced by a coating upon the surface of the skeletal framework and by a filling of most of the permeable porous stone void spaces with the polymer or polymer composition component. In some combinations, the resultant tensile strength may be greater than the additive tensile strength of both components. This may be due to internal stresses acquired during solidification of the polymer component, possibly as a result of slight shrinkage.

However, in all variations, the solidified polymer component reinforces the porous stone skeletal framework component by being solidified upon the interior walls of the porous stone framework. Varieties may range from a film coating on most of the interior walls to a nearly complete filling of the evacuated void spaces.

The stone look is a highly desirable quality of a great number of manufactured compositions. The multiple use dimensional stock product and the multiple use solid surface ornamental and architectural article can have varying degrees of solidified polymers surrounding their previously formed stonelike skeletal framework structure. The striking resemblance to a natural stone product, the lighter weight of the polymer, and the enhanced decorative and structural qualities provide an unlimited variety of uses.

Many varied and highly decorative articles of manufacture can be produced by the use of this invention. Vivid expressions of color, texture, and grain can be attained. The number of combinations and permutations of this polymeric stone product is enormous.

Decorative and functional architectural uses abound. Thin, light-transmissive shapes can be produced with more variations than stained glass. Solid surface materials such as countertops, window sills, and thresholds provide greater diversity than traditional marble and granite. Light weight and durable floor, wall, and ceiling tiles or panels can be mass produced. Colorful aggregate sizes may also be produced for decorative construction and landscape applications.

Most articles that can be made by turning on a lathe can also be produced as a polymer impregnated porous stone article. Lightweight stone furniture can be fabricated in solid or assembled forms. Highly decorative lamp bases are easily mass produced. Many decorative and functional home and office accessories resembling natural rock are easily manufactured.

As an artistic medium for ornamental sculpture, polymer impregnated porous stone is unexcelled. The porous stone can be easily pre-formed to a predetermined size and shape prior to impregnation, and easily machined and finished after impregnation. Also, small polished or coated pieces of this unique material can be used as components in fine costume jewelry.

Color coded, general use abrasive masses can be produced in many shapes and sizes, by incorporating an abrasive porous stone with a polymer composition. Interesting and functional fire starters for fireplaces and campfires can be made by using a highly porous stone and a flammable wax polymer composition component.

Dimensional stock materials, or blanks, having a relatively consistent coloration and grain throughout can be produced and further fabricated into an endless array of decorative products. Most dimensional stock may be sawn, drilled, tapped, threaded, routed, machined, and finished. The polymer composition component of dimensional stock is generally a solid, durable, and machineable material.

Almost any decorative application that has been exhibited by natural wood, or natural or artificial stone, can also be exhibited by polymer impregnated porous stone. More specific uses of this invention will become apparent throughout this description.

Other objects and advantages are: that a complex polymeric stone shape can be produced without the use of a mold the porous body is the mold and functions as a containment matrix for the polymeric matrix that the framework of the porous body may be treated prior to impregnation to provide additional enhanced decorative and structural qualities; that bonding of aggregated polymer impregnated pre-formed bodies is through the aggregate particle in addition to enclosing the aggregate particle; and that preforming to size and shape is advantageous to postforming a dimensional stock sheet or block. Still further objects and advantages will become apparent from a consideration of the ensuing description and drawings.

### DESCRIPTION OF THE DRAWINGS

All drawings are cross-sectional representations. Most are partial cross sections. The letter “S” represents an external surface portion of any particular figure. Drawings of the porous stone structure are purely diagrammatic representations. An actual porous stone framework can have considerable variations. The drawings are not meant to represent any particular sizes of the materials or equipment. Coating thickness, as drawn, is exaggerated for clarity. The terminologies “porous stone” and “pre-formed porous stone” are used synonymously in the drawing descriptions and throughout this specification.

FIG. 1 Shows a pre-formed porous stone structure.

FIG. 2 Shows a polymer impregnated stone structure with a substantial void filling.

FIG. 3 Shows a polymer impregnated porous stone structure with a substantial coating upon the skeletal framework walls.

FIG. 4 Shows an example of a polymer impregnated porous stone structure with a pre-treatment film coating.

FIG. 5 Shows the structure of a solid agglomerated aggregate article with mechanically bonded accessory aggregate materials.

FIG. 6 Shows the structure of an open-structured agglomerated aggregate article.

FIG. 7 Shows the structure of an agglomerated layered article

FIG. 8 Shows a poured textural coating with polymer impregnated stone aggregate chemically bonded to another matrix material.

FIG. 9 Shows an agglomerated coated article.

FIG. 10 Shows an agglomerated accessory component.

FIG. 11 Shows an agglomerated bulk form article.

FIG. 12 Shows an agglomerated thin planar article (enlarged section).

FIG. 13 Shows an example of an exposed internal structure article.

FIG. 14 Shows the external surface of a finished article with a pore filling and coating.

FIG. 15 Is a combination drawing showing various materials and equipment involved in a vacuum/pressure impregnation process.

FIG. 16 Shows an individual article (cut in half to show a cross section).

### REFERENCE NUMBERS IN DRAWINGS

1 Skeletal framework

2 Continuous void

3 Blind void

4 Totally enclosed void

5 Solidified polymer (or polymer composition)

6 Filled porosity

7 Partially filled porosity

8 Unfilled porosity

9 Coating in contact with skeletal framework

10 Polymer impregnated pre-formed porous stone

11 Containing matrix (polymer or polymer composition)

12 Accessory aggregate

13 Connecting adhesive (polymer or polymer composition)

14 Different matrix composition

15 Substrate

16 Gel coat (accessory)

17 Threaded insert (accessory)

18 Epoxy adhesive (accessory)

19 Unimpregnated porous stone aggregate

20 Pre-assembly adhesive, cement, or matrix composition

21 Secondary solidified polymer impregnant composition

22 Pre-formed porous stone

23 Fluid impregnant (impregnating fluid)

24 Containment vessel

25 Containment mold

26 Internal reservoir

27 External reservoir

28 In line valve

29 Overflow chamber

30 Recessed perforated attachment

31 Vacuum/pressure chamber

### COMPOSITE STRUCTURE

In order to describe the composite structure of a polymer impregnated stone, it is necessary to understand the basic types of porosity and permeability present in most natural porous stone bodies, and in other porous bodies artificially constructed to resemble a natural porous stone body. The structure of most porous stones is generally not homogenous. Many complex variations may exist. However, there are some basic common characteristics as illustrated in FIG. 1.

Both natural and artificially constructed porous bodies include a substantially continuous, three dimensional, interconnected, labyrinthic skeletal framework(1) with various interstitial spaces adjacent to the interior walls of the skeletal framework(1).

Three general arbitrary size classifications of the interstitial spaces may be present: micro-porosity, macro-porosity, and textural-porosity. Micro-porosity exists in the form of very small voids, which are visible only under magnification. Macro-porosity is generally visible to the naked eye in the form of small (generally less than one-sixteenth of an inch across) voids, vesicles, and cracks. Textural-porosity, as defined by this invention, includes larger (generally greater than one-sixteenth of an inch across) generally visible cavities, vugs, channels, and fissures, which are clearly visible at the surface of a porous body from an arm's length distance. These three size classifications may appear at the surface and also may exist throughout the internal portions of the porous stone. Any particular size or combination of sizes may be present.

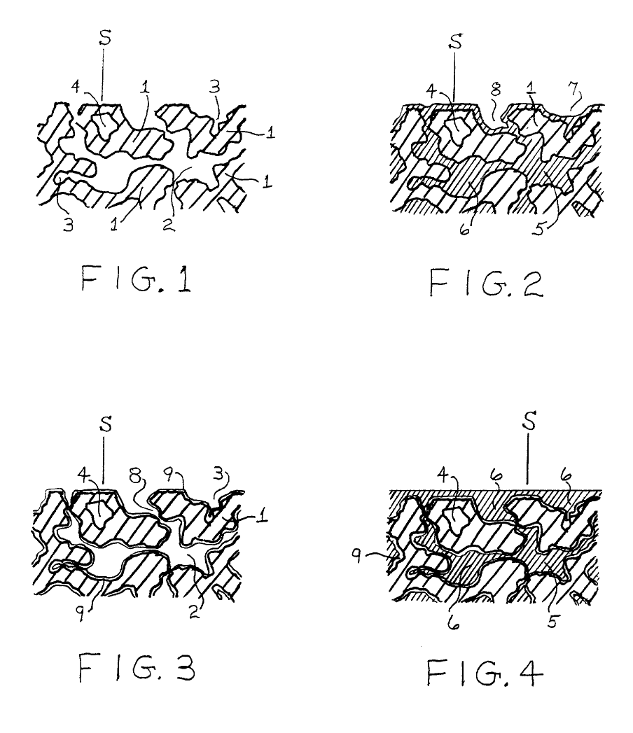

Each of these three general size classifications are further defined by three permeability classifications of the interstitial spaces as first illustrated in FIG. 2: continuous voids(2), blind voids(3), and totally enclosed voids(4). Continuous voids(2) penetrate throughout the stone, and open to more than one location at the surface of the stone. Continuous voids(2) may also branch into blind voids(3) within the stone framework. Blind voids(3) have access to the surface of the stone, but terminate within the stone framework. Both are permeable to various fluids dependent upon their size in relationship to the viscosity of various fluids. Totally enclosed voids are isolated within the skeletal framework(1) structure of the stone, do not open to the surface of the stone, and are generally impermeable.

Permeable voids evacuated of air, gases, and moisture allow other fluids a space to occupy. The skeletal framework(1) provides matrix means for containing other fluids or solids. As shown in FIG. 3, the skeletal framework(1) functions as a stonelike matrix for containing a solidified polymer or polymer composition(2). In the product of this invention, and in an article of this invention, the stonelike matrix simultaneously functions as a stonelike bulk filler for adorning a solidified polymeric matrix in a manner simulative of natural mineral markings being exhibited throughout any substantial cross section of the product of this invention.

The solidified polymer or polymer composition(2) provides a solidified polymeric matrix means for containing the skeletal framework(1) stonelike matrix (or bulk filler). In this invention, the solidified polymeric matrix simultaneously functions as a substantially continuous, three dimensional, substantially solid, molded void filling and coating for structurally reinforcing the stonelike matrix in a manner simulative of a natural rock void filling or coating exhibited throughout any substantial cross section.

The stonelike matrix and the polymeric matrix are mutually interlocked in a manner simulative of a natural rock double matrix structure being exhibited throughout any cross section.

A preferred double matrix composite structure of polymer impregnated stone (FIG. 2) includes the skeletal framework of a pre-formed natural or artificial porous stone body(22), and a substantial filling of most of the permeable continuous(2) and (if they exist) blind(3) micro-porosity or macro-porosity or textural-porosity, or any combination of porosity therein with a solidified synthetic or natural polymer, or polymer composition having a high concentration of polymer therein(5). Unfilled totally enclosed voids(4) of any size may or may not be present, depending upon whether they exist as part of the porous stone body. The solidified polymer or polymer composition(5) filling, formed from a fluid impregnant(23), also acts as a coating upon the skeletal framework(1) of the porous stone body(22). This solidified impregnant composition coating(5) may range from an extremely thin film on the exposed surface are of the polymer impregnated stone to a relatively thick coating which envelopes most of the polymer impregnated stone.

A composite structure with a thin film coating of the impregnant composition(5) exhibits a surface texture of a pre-formed porous stone (similar to the external surface of FIG. 2). A composite structure with a heavier coating of impregnant composition(5) exhibits a smoother surface or a molded surface as a result of containment during processing (similar to the external surface of FIG. 4). The external surface is not a significant factor for an unfinished dimensional stock product, but is extremely significant in a further manufactured article.

An alternative preferred composite structure of a polymer impregnated stone (FIG. 4) is identical to the above description, except that the pre-formed porous stone body skeletal framework (1) is pre-treated in any manner prior to fluid polymer impregnation that does not substantially impair the impregnation process. Pre-treatment of the porous stone body skeletal framework(1) may include but is not limited to: dyeing, pigmenting, or electroplating; film coating(9) with a primer, coupling agent, or thermal expansion buffer; reacting with a bleaching or etching agent; or any compatible combination of pre-treatment. FIG. 3 is an example.

Each of these above described two preferred embodiments has its own distinct advantage. An embodiment (FIG. 2) with an untreated skeletal framework(1) is generally less expensive to produce. However, an embodiment (FIG. 4) with a pre-treated skeletal framework(1) can provide additional decorative or structural qualities. Both embodiments can have a wide range of variations, depending upon the extent of filling of the various porosity sizes.

Many variations of these two embodiments may exist due to variations in porosity size, permeability, and the degree of containment of the fluid impregnant(23) during and prior to solidification.

Some or all of the continuous(2) and blind(3) micro-porosity of FIG. 1 may or may not be filled (as somewhat shown in FIG. 2 and FIG. 4), depending upon the viscosity of the fluid impregnating polymer or polymer forming composition and the degree of positive and negative forces applied during processing. If the porous stone contains a high percentage of micro-porosity, then very low viscosity impregnants and higher impregnation pressures are required for thorough and even penetration of the fluid impregnant.

Any continuous(2) or blind(3) macro-porosity existing in either previously described embodiment (FIG. 2 and FIG. 4) or in most variations will generally be substantially filled with a polymer composition(5). This is probably due to capillary attraction that inhibits draining of the fluid impregnant(23) from the macro-porosity. Therefore, pre-formed porous (FIG. 1) stones that contain high percentages of macro-porosity will generally be substantially filled by distribution of a fluid impregnant(23) throughout the internal structure. However, in cases of extremely low viscosity fluid impregnants(23), draining by light centrifugal force prior to solidification will reduce the amount of macro-porosity filling somewhat.

Internal continuous(2) and blind(3) textural-porosity may or may not be filled, depending upon the degree of containment of the fluid impregnating polymer or polymer forming composition(5) within the internal structure of a porous stone during processing. Textural-porosity that exists totally within the stone may be completely or partially surrounded by macro-porosity, or micro-porosity, or both. After filling by impregnation, capillary attraction within the surrounding macro-porosity and micro-porosity assists in preventing most of the fluid impregnant(23) from escaping to the surface of the impregnated porous stone. This usually results in a substantial filling(6) of the interior textural-porosity with the polymer composition(5). Internal textural-porosity may also be unfilled if the fluid impregnated porous stone is allowed to drain or is lightly centrifuged prior to solidification. This can somewhat resemble FIG. 3. This is desirable in such cases where individual structural enhancement is acceptable, such as for mainly decorative usage. If the fluid impregnated porous stone contains a high percentage of textural-porosity and a greater degree of filling is desired, then higher viscosity fluid impregnants may be employed. In these cases, containment by low RPM rotation or a mold is generally required to assure substantial incorporation of a polymer or polymer composition(5). In some cases of very large porosity sizes, much of the internal textural-porosity will only be partially filled by rotation containment. This is still more than sufficient for enhanced structural integrity.

Textural-porosity that opens at the surface of the porous stone (as shown in FIG. 2 and FIG. 4) may be fully(6) or partially(7) filled, if the fluid impregnating polymer composition was physically contained, during solidification. For example, a surrounding mold will completely contain the fluid impregnant within the surface textural-porosity. Also, low RPM horizontal or multi-axial rotation during solidification will partially contain the fluid impregnant in some of the smaller textural-porosity voids. Physical containment by macro-porosity and micro-porosity also acts as an internal mold, depending upon the location and orientation of the surface textural-porosity. Surface textural-porosity may be unfilled(8) if the fluid impregnant is allowed to flow out of these larger voids prior to solidification of the polymer composition. These unfilled(8) voids may or may not have a substantial film coating of the polymer composition, depending upon the viscosity of the impregnant; the length of time for solidification; the degree of draining or rinsing; and whether or not rotation was implemented during solidification. Also, the macro-porosity and micro-porosity exposed to the surface may drain off somewhat leaving a more pronounced, textured, surface effect.

A third preferred composite structure of a polymer impregnated porous stone (FIG. 3) includes a pre-formed natural or artificial porous stone body(22) and a film coating(5) having a high concentration of polymer therein adhered to a substantial portion of the interior walls of the porous stone body skeletal framework(1), that are adjacent to the permeable interstitial spaces. This film coating matrix(5) is similar to a pre-treatment film coating(9), and is further described near the end of the pre-treatment step for forming a polymeric matrix stone product.

Many variations of porosity filling with a polymer or polymer composition(5) are possible in the above preferred embodiments. The above variations are given as examples, and are not meant to limit the scope of this invention. The various structures are meant to resemble the structure of a wide range of natural rocks, including porous natural rocks. However, in all variations, the polymer or polymer composition component(5) is still relatively evenly distributed throughout most of the interior untreated or pre-treated porous stone framework(1). In some variations this distribution may be partially or fully in the form of a coating rather than a filling.

### COMPOSITE COMPONENTS

The physical nature of the porous stone skeletal framework or porous body skeletal framework component of this invention largely determines the decorative grain, the surface texture, and the amount of the incorporated polymer composition component. High porosity of a porous body results in a very lightweight, impregnated stone product, due to the fact that the polymer composition is usually of lower density than the porous stone framework material. The surface hardness and abrasion resistance of the impregnated stone product will also be affected by the inherent hardness of the porous stone framework material.

The porous stones or porous bodies of this invention (for example, FIG. 1) must have a substantial dispersion of continuous(2) voids, in order for the impregnating polymer composition(5) to interfinger throughout a significant portion of the skeletal framework(1) (see FIG. 16 for an example of this). Blind voids(3) or totally enclosed voids(4) may or may not be present. The porous stones of this invention may have any combination of micro-porosity, macro-porosity, or textural-porosity. The permeable continuous(2) and (if existing) blind(3) void spaces combined may be at least about five percent in some rare cases of the total volume of any pre-formed porous stone body in order to produce a significant decorative or structural effect when combined with an impregnated polymer or polymer composition(5). The permeable spaces may also be as high as ninety-five percent in some cases. Twenty to eighty percent is preferred. Thirty-five to sixty-five percent is most preferred.

The skeletal framework of the porous bodies of this invention has relatively low compressional strength and relatively low tensile strength. As such, these porous bodies can be easily pre-formed into many variations of external size and external shape prior to impregnation.

The porous stonelike body may be a naturally occurring porous rock or mineral, or may be an artificially constructed or synthesized porous body that somewhat resembles the structure of a porous natural rock or mineral. The skeletal framework(1) of the porous stonelike body may be optionally internally colored, for example with a dye, pigment, or metallic material in contact with a substantial portion of the interior walls of the skeletal framework(1) that are adjacent to the permeable interstitial spaces. However, this material should not appreciably impair substantial impregnation of a fluid impregnant(23) throughout the evacuated permeable interstitial spaces of the pre-formed porous stone. The skeletal framework of the porous body may also optionally have a thin film coating of any material deposited upon a substantial portion of the interior walls of the skeletal framework(1) before or after pre-forming of a porous body. The interior walls of the skeletal framework(1) may also be electroplated. The skeletal framework(1) of a porous body may also optionally have been previously reacted with any material to alter the form or appearance of the interior walls of the skeletal framework(1) that can be contacted via the adjacent permeable interstitial spaces. Any method of pre-treatment to enhance the decorative and structural qualities of the finished product may be employed.

Naturally occurring rocks or minerals may include, but are not limited to: glassy pumice, devitrified pumice, scoria, tuff, coarse volcanic ash and cinders, lapilli, permeable sandstones, loosely consolidated mudstones and earthy deposits, coquina, coralstone, tufa, chalk, weathered rocks and minerals, mineral clusters with open-lattice void spaces, siliceous and calcareous coral and sponge skeletal matter, and skeletal bone matter. Porous rocks of volcanic origin are most preferred, especially pumice, scoria, and tuff. Also preferred are porous rocks of sedimentary origin, especially tufa, coquina, coralstone, and softer permeable sandstones.

Natural gemstone minerals of poor quality due to chalking, cracks, or earthy inclusions are not considered porous stones in this invention. They generally do not have a significant amount of substantially dispersed continuous void spaces. However, earthy deposits and open-lattice mineral clusters are included.

Artificially constructed or synthesized porous stones that somewhat resemble the structure of a natural porous rock or mineral may include, but are not limited to: cinders, porous slag, porous artificial pumice, and synthetically produced artificial tufa. Also, any aggregate composition that has been constructed by coating individual particles with any organic or inorganic adhesive, cement or bonding agent, and then contacting and adhering the coated particles in an arrangement to allow void spaces between many of the coated particles, qualifies as an artificial porous stone.

High compressive strength concrete, concrete masonry units, and ceramic bricks, are not considered artificial stones in this invention. However, low strength, open grained, porous aggregate structures bonded together with portland cement or a fused ceramic cement are included in this invention as an artificial porous stone component.

This invention applies to the impregnation of any previously produced artificial porous stones and to any that may be so constructed in the future, especially for the purpose of impregnating with a molten polymer or liquid polymer forming compositions.

The physical and chemical nature of the solidified polymer or polymer composition component(5) of this invention largely determines the overall color, structural integrity, hardness, machineability, polishability, chemical resistance, heat resistance, and flammability resistance of the impregnated porous stone product.

Any synthetic or natural polymer composition or polymer forming composition that will not adversely affect the porous stone framework material may be incorporated into this invention. The solidified polymer composition(5) may be a cured resin composition or it may be a solidified product of a molten thermoplastic composition. Compatible mixtures of monomers, resins, and co-polymers may be included in the polymer forming composition component.

The solidified polymer compositions(5) in this invention may include, but are not limited to: epoxy resins, acrylic resins, polyester resins, vinyl resins, allyl resins, polystyrene resins, acronitrile resins, butadiene resins, silicone resins, polyurethane resins, phenolitic resins, nylon resins, mineral resins, plastisols, cellulostics, hot-melt glues, asphalts, waxes, and paraffin-polymer blends.

An impregnated solidified polymer composition(5) may be a solidified thermosetting or thermoplastic polymer alone, or the composition(5) may include, but is not limited to: pigments, powdered metals, dyes, fillers, extenders, plasticisers, ultraviolet absorbers, degradation stabilizers, flame retardants, and oils.

Solidified or cured polymer compositions(5) may be of any color, or they may be water clear. They may be transparent, translucent, or opaque. They may be fluorescent or phosphorescent. They may contain a minimal amount of reaction by-products such as water or entrapped vapors. The polymer compositions(5) are substantially solid, but they may in some instances, have a porous nature. Color may be evenly distributed within the impregnated void spaces, or may grade into stratified layers.

Linear stratification can occur if high density pigments, powdered metals, or fillers are allowed to settle out prior to gelling of the fluid polymer or polymer forming composition. Concentric stratification may occur in the impregnated macro-porosity and textural-porosity by the filtering action of any surrounding micro-porosity that is smaller in size than pigments and fillers of the impregnating polymer composition. Under sufficient pressure, highly fluid portions of a polymer forming composition may sometimes penetrate the micro-porosity and leave the larger particulate matter compressed against the walls of the macro-porosity and textural-porosity.

The structural integrity of polymer impregnated porous stone may vary considerably, depending upon the physical nature of the solidified polymer composition(5). The solidified polymer composition(5) may vary at room temperature from rigid to flexible to elastromeric. It may be a solid or a semi-solid. Hardness, machineability, polishability, chemical resistance, heat resistance and flammability resistance may vary widely, depending upon the particular composition of polymers and additives or modifiers, and the intended product usage. Relatively water resistant solidified polymer compositions are preferred in most applications. Hard, durable, chemical resistant, machineable solidified synthetic resin compositions are preferred in most architectural, furniture, and jewelry applications. Weather resistant compositions are preferred for exterior applications. However, almost any solid or semi-solid composition may be used for purely ornamental use and in many architectural applications. Transparent to translucent heat-resistant polymer compositions are preferred for light-transmissive applications. Heat resistant compositions are preferred for abrasive applications. For versatility, epoxy resin compositions are most preferred. Polyester, acrylic, and vinyl resins are also preferred for versatility.

### ARTICLES OF MANUFACTURE

The product of this invention is a polymeric stone. As such, it may be used as a broad range architectural product, aggregate product, ornamental sculpture product, decorative accent product, furniture and accessories product, or jewelry product. Alternate uses are as an abrasive product and as a novelty fire starting product. The abrasive product may also be a slip resistant architectural product. The polymeric stone may be light-reflective or light-transmissive. An article of manufacture may have many surface variations. There are several preferred embodiments of this polymeric stone article. They all contain at least one double matrix individual polymer impregnated porous stone bearing a striking resemblance to the texture, structure, and formation of a natural rock. Since the skeletal framework(1) can vary considerably, a wide range of natural rocks can be simulated. Each preferred embodiment presents a different variation in the physical appearance of the final product, especially in surface texture. Many specific examples are provided throughout this description.

A preferred article of manufacture (an example is shown in FIG. 16) includes a singular individual polymer impregnated pre-formed porous stone double matrix internal composite structure as previously described (FIG. 2, FIG. 3 and FIG. 4) and at least one external surface in which the surface porosity or degree of void filling is predominantly substantially filled(6), partially filled(7), or substantially unfilled(8). A surface of the article exhibits the texture of a porous stone modified by the degree of containment during solidification or curing of the polymer impregnant(23). Minor areas of flashing, solidified drippings, and other surface imperfections may be removed to increase utility.

The maximum size of individual polymer impregnated stone articles is dependent upon the available size of the porous stone component, the machinery available to process it, and internal stresses developed during solidification or curing of certain polymer composition impregnants(23). The minimum size is dependent upon the porosity size of a pre-formed porous stone. For example, individual articles less than one-sixteenth of an inch in any dimension may be produced with some porous stones containing continuous permeable micro-porosity.

Small and medium sizes (from about one-sixteenth of an inch up to several inches across) of any shape can be used in many aggregate applications including, but not limited to: aquarium, terrarium, and landscape gravels or cobbles; decorative, textural, and slip-resistant coating additives; poured terrazzo flooring aggregate; broadcast aggregates for stucco, plaster, and concrete; poured concrete aggregate finishes; and as aggregates or fillers for any type of cast or molded article.

An individual pre-formed polymer impregnated porous stone may be in the shape of dimensional stock or blanks for further uses or other industries. Polymeric dimensional stock may include, but is not limited to: blocks, boards, sheets, veneers, rods, tubes, channels, angles, and spheres.

Polymeric dimensional stock may also be a functional decorative article of manufacture. Examples include, but are not limited to: floor, wall, and ceiling tiles or panels; wall and roof shingles; structural blocks or columns; window sills, stair treads and risers, partition caps, and door thresholds; shelving, bookends, cabinet doors, and architectural moldings and trim; countertops, table tops, and cutting boards; and light-transmissive translucent window panes and panels.

Besides dimensional stock, polymeric stone articles can also be in any imaginable shape that the individual porous stone can be made into prior to polymer impregnation. Examples of such pre-formed shapes(22) include, but are not limited to: lathe-turned shapes, carved or sculpted shapes, engraved shapes, or thermo-formed shapes. Any combination of shapes is also included.

Polymer impregnated pre-formed lathe-turned articles include, but are not limited to: lamp bases, lamp shades, bowls, cups, plates, round boxes and lids, planters, vases, candle holders, pedestals, spindles, columns, knobs, game pieces, and furniture components.

Polymer impregnated pre-formed sculpted or carved porous stone articles are only limited by the imagination of the designer and can be of any possible shape. They may have any combination of planar, curved, or textural surfaces. They can be for interior or exterior decorative or architectural use, depending upon the particular porous stone and polymer composition(5). They can be component parts of larger assembled items such as, but not limited to: monuments, large sculpture, fountains, and decorative displays. They can be designed to have various components, such as lamp parts, jewelry parts, or clock inserts, assembled or attached after the complete processing of the impregnated porous stone. FIG. 16 clearly illustrates such a design. Low cost window displays of sculpted, light-weight artificial rock can be made in many color variations by incorporating an inexpensive waxy semi-solid polymer composition into a pre-sculpted porous stone(22).

Of special importance are articles sculptured with an internal space and relatively thin walls. A sufficient light source placed within the internally sculpted space can effectively transmit light through some compositions and produce a dramatic glowing stone effect. Glassy pumice impregnated with a transparent epoxy resin is a prime example.

Pre-engraved articles may have ornamental designs or lettering imposed on the surface of the porous stone. They may be of any shape or may simply be somewhat planar for use as decorative signs, plaques, or grave stones.

Naturally pre-formed cobbles and boulders can be hollowed out, flattened on the bottom, and polymer impregnated for use as planters or decorative bases for cut, dried, or artificial flowers. They can also be shaped as floating rock novelties for ponds, pools, and fountains.

Thermo-formed porous stone shapes(22) are usually relatively simple forms that can be produced by draping, slumping, or slight pressure upon a meltable porous stone structure without appreciable reduction of porosity. Impregnation takes place after the thermo-forming process. Articles such as planters, bowls, vases, and simple relief shapes can be produced in this manner.

Many articles of manufacture can be produced from a single pre-formed individual porous stone(22) by polymer impregnation. The above examples are not meant to limit the scope of this preferred embodiment.

However, many porous stones that occur in nature are not available in large quarry size blocks. In order to include the smaller sized porous stones as larger articles of manufacture, it is necessary to include multiple unit polymer impregnated porous stones in this invention. There are also instances where the polymer impregnated stone may be in contact with other materials incorporated prior to solidification or curing of the fluid polymer impregnating composition. Incorporation of other materials expands the diversity of an individual polymer impregnated stone article.

Therefore, a second preferred article of manufacture is an agglomerated article including a polymer impregnated pre-formed porous stone double matrix internal composite structure as previously described (FIG. 2, FIG. 3 and FIG. 4) and at least one external surface with a range of surface porosity filling as described in the previous preferred article, in which the fluid polymer impregnant has contacted and incorporated one or more such impregnated porous stones(10) of similar or differing sizes and color, or any other material, prior to complete solidification or complete curing of the polymer impregnant (FIG. 5 through FIG. 12). A surface of the article exhibits the texture of a porous stone modified by the degree of containment during solidification or curing of the polymer impregnant(23). The additional incorporated material may also affect the surface texture and appearance. Minor areas of flashing, solidified drippings, and other surface imperfections may be removed to increase utility.

For purposes of this description, agglomerated articles include two or more materials, one of which is always a polymer impregnated pre-formed porous stone(10). In an agglomerated article, the solidified polymer impregnant(5) may be in contact with another material as a proximity material or as a mechanical or chemical bonding material in the form of an adhesive(13) material for connecting, or as a matrix for containing(11) another porous stone or porous stones and any other component or components. The other component, or components, may include, but are not limited to: a similar polymer impregnated pre-formed porous stone(10) of the same or different color, a different polymer impregnated pre-formed porous stone(10) of the same or different color, or any other porous or non-porous material. The other component or components may be emplaced before, during, or after the impregnation process, but always before the final solidification or complete cure of the polymer composition impregnant(23).

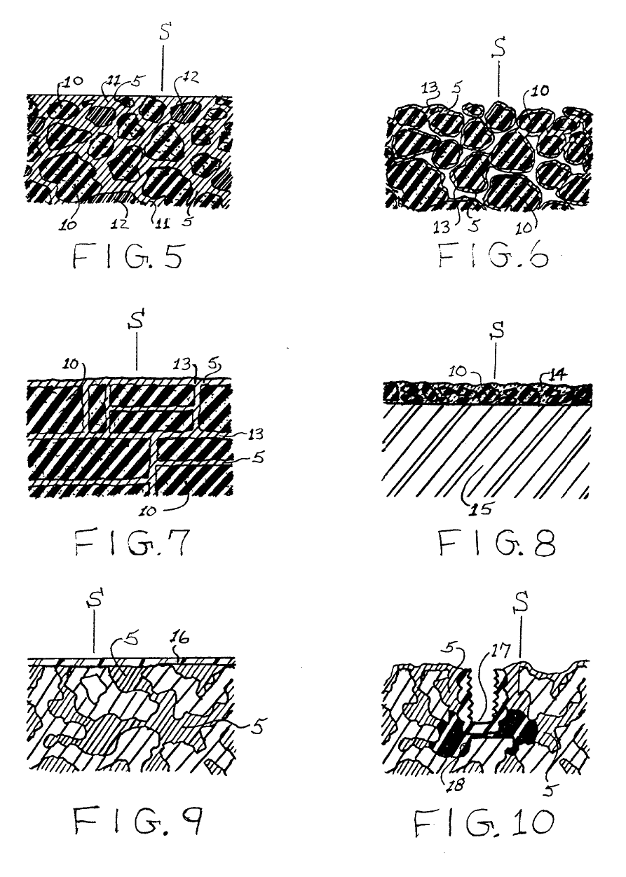

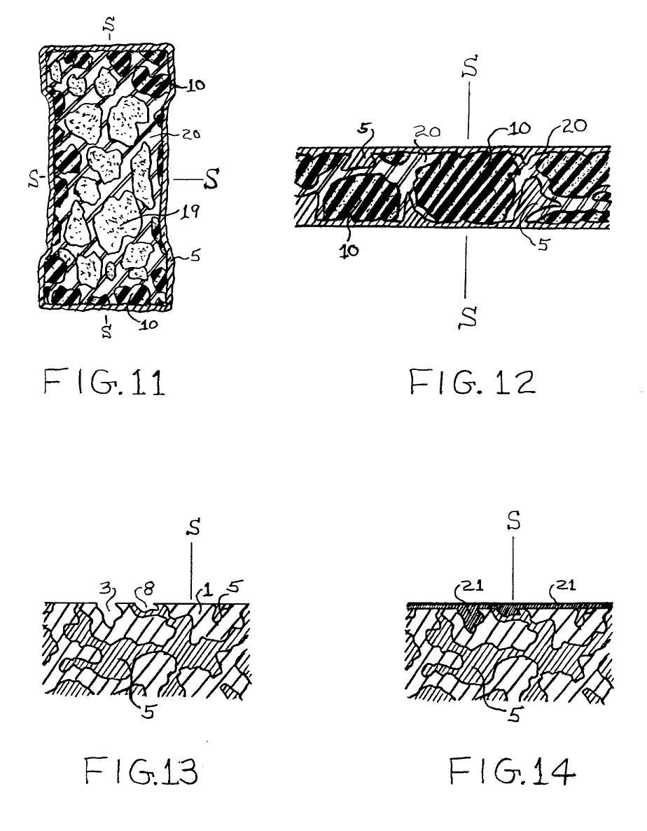

Variations of agglomerated polymer impregnated pre-formed porous stone articles include, but are not limited to: aggregated articles (FIG. 5, FIG. 6, FIG. 8, FIG. 11, and FIG. 12), layered articles (FIG. 7), coated articles (FIG. 9), articles with incorporated accessories (FIG. 5, FIG. 10, and FIG. 12), and the polymer impregnate pre-formed porous stone as an accessory component or components of other articles of manufacture (FIG. 8 and FIG. 9). Any combination of such articles is also included.

Agglomerated articles may be produced in any of the sizes and shapes of individual articles, and include all of the previously mentioned uses, with the exception of the individual very small sizes used in aggregate applications. However, grouped agglomerated aggregates may still be used in aggregate applications resembling conglomerated or brecciated aggregate particles of slightly larger size.

There are many additional uses afforded by contacting the polymer impregnant(23) with another material prior to solidification or complete cure. Also, more complex arrangements are made available with agglomerated articles. The uses and arrangements presented in the drawings and description not meant to limit the scope of this invention.

In agglomerated aggregate articles, the solidified polymer or polymer composition(5) also functions as a binder or adhesive(13) at the point of contact of each impregnated pre-formed porous stone(10) component. In this manner, open-structured agglomerated aggregates (FIG. 6) may be formed by draining some of the fluid polymer composition(23) prior to solidification. The solidified polymer or polymer composition(5) may also function as a matrix(11) material which fills the spaces between each impregnated pre-formed porous stone particle(10), and binds the entire mass together. In this manner, solid agglomerated aggregate products (FIG. 5) may be formed.

Agglomerated aggregate articles may be cast, and take the shape of their mold, or they may be attached to the surface of a substrate by the adhesive action of the polymer or polymer composition(5). Cast agglomerated aggregates can be made to resemble many natural rocks depending upon the aggregate size and color, the degree of transparency of the polymer or polymer composition(5), and the physical arrangement of the impregnated pre-formed porous stone aggregates(10). They may be of any color or combination of colors, and may resemble massive, crystalline, conglomerated, brecciated, veined, or layered natural rocks. Agglomerated impregnated pre-formed porous stone aggregate(10) (similar to FIG. 5 and FIG. 6, prior to pouring) may also be poured over any compatible substrate prior to solidification or curing to provide a decorative slip-resistant textural surface to floors, sidewalks, ramps, and steps. This use is similar to FIG. 8, but with a containing matrix composition(11) being the same solidified polymer or polymer composition(5). It can also be used as a decorative textural coating adhered to ornamental items as a partially solidified slurry or paste prior to complete solidification.

Agglomerated aggregate articles may also contain accessory aggregates(12) of any other material incorporated prior to solidification (FIG. 5). Alternatively, uncured or partially solidified polymer impregnated pre-formed porous stone aggregates(10) may be an accessory component or components of any other agglomerated aggregate material mixture, and thus become an integral accessory component upon solidification or complete curing.

In a similar manner, the polymer composition(5) may also function as a binder to a different matrix composition(14) that has been introduced following the impregnation process. For example, aggregate size pre-formed porous stones(10) previously impregnated with a fluid polymer composition(23) that has not yet solidified or fully cured (for example, FIG. 6 before solidification), may be mixed as accessory components (FIG. 8) with a similar or different fluid polymer composition matrix(14) and then cast in a mold or poured onto a substrate(15) as a textural coating (FIG. 8). This allows for greater use of cost reducing filler materials in the matrix, than if the solidified polymer impregnant(5) alone is used as the matrix material. The matrix may or may not chemically cross-link with the porous stone polymer impregnant. However, cross-linking is preferred for a stronger product. The polymer impregnated pre-formed porous stone aggregates(10) act as accessory components in this variation.

Agglomerated layered articles (FIG. 7) are similar to solid agglomerated aggregate articles (FIG. 5) except that the pre-formed porous stone(22) components have a roughly planar surface. These components can be stacked, or set side by side, or both to form any degree of three-dimensional contact. They may range from a simple two-component form to game boards to complex mosaic assemblies. The solidified polymer impregnant(5) of the pre-formed porous stone(22) functions as a binder or adhesive(13) between the roughly planar surfaces. Flatter shapes of individual or groups of individual polymer impregnated pre-formed porous stones(10) may be adhered to a compatible substrate, prior to solidification or curing. For example, a thin tile-shaped porous stone(22) may be impregnated and then bonded to a concrete or hard board backing with the same polymer impregnating composition(23). Similarly, multiple veneers or inlays can be incorporated onto or into any compatible substrate, as an accessory component.

In a like manner, accessory components of other materials may be incorporated within the agglomerated layered articles. For example, a turned lamp base may be composed of alternate layers of porous stone(10) and wood. The layers may be spot-glued together, shaped on a lathe, and impregnated as a multiple unit agglomerate. The polymer impregnant(23) will solidly bond the porous stone component(10) to the wood component during processing.

Agglomerated coated articles (FIG. 9) are those in which a surface coating contacts the polymer impregnating composition(23) prior to solidification or complete cure of the polymer impregnant(23). For example, a mold surface can be pre-coated with a clear resin gel coat(16). Then, a pre-formed porous stone(22), or an aggregate mix containing pre-formed porous stones(22), can be placed against the coated mold surface, impregnated with a fluid polymer composition(23), and allowed to solidify or cure against the coated mold surface. The resultant attachment of the polymer composition(5) to the gel coat(16) forms an agglomerated coated article. The polymer impregnated porous stone(10) now has a clear finished surface coating.

Another example is to apply a compatible clear film coating to a partially solidified or partially cured polymer impregnated pre-formed porous stone(10). Upon final solidification or cure of both the polymer impregnant(23) and the clear film coating, an integrally coated agglomerated article results.

Agglomerated articles with incorporated accessory components have previously been described in aggregated and layered articles. However, a simple variation of an agglomerated polymer impregnated porous stone article is an individual porous stone with a single accessory component embedded during processing (FIG. 10). For example, a threaded insert(17) (used to facilitate subsequent mechanical attachment) may be placed in a hold drilled into a porous stone. During processing, the insert becomes an integral part of the finished product, thereby resulting in an agglomerated article with an incorporated accessory component. Another example is a string or metal wire wrapped around a lathe-turned pre-formed porous stone as a decorative accent. Upon impregnation and solidification, the accent material becomes incorporated into the surface coating portion of the impregnated porous stone. Still another example of an agglomerated article is a wick material inserted into a pre-drilled hole in a porous stone. Upon impregnation of the entire assembled article with a flammable waxy polymer, a decorative fire starter is produced.

Another variation of an agglomerated polymer impregnated pre-formed porous stone article is one in which the impregnated porous stone(10) becomes an accessory component to another article. Some examples have previously been described as aggregate mix components, porous stone textural coatings of other articles, and as layered article components. Of particular importance is the use of synthetic resin impregnated pre-formed porous stone aggregate(10) as an accessory aggregate or major aggregate(10) in a resinous terrazzo flooring composition. The porous stone aggregate(22) is impregnated with a fluid synthetic resin forming impregnant(23) prior to mixing with the terrazzo flooring matrix(14). During curing, the impregnating resin(23) can chemically cross-link with the matrix material(14) and thus produce an integrally bonded terrazzo flooring composition of exceptionally high bonding strength to the porous stone aggregate component. FIG. 8 is also an example of this, and can be further ground and sanded to a smooth surface, as will be discussed in another preferred embodiment of this invention.

Another example of an agglomerated article is an inlay incorporated into another material as an accessory component during processing. An example is a lathe-turned wooden article in which a porous stone is cut(10), fitted, and adhered into a matching recess in the surface of the wood. The porous stone(10) may then be additionally machined to conform to the surface of the turned wooden object. After impregnation of the entire article and solidification or curing of the polymer impregnant(23), the inlay becomes an integrated component of the completed article.

Another example of a polymer impregnated accessory component is a polymer impregnated pre-formed porous surface layer of weathered stone, in which the interior of the stone is relatively impermeable and the surface of the stone is relatively porous due to the effects of natural weathering. For example, articles of this type can be naturally-eroded decorative stones with porous weathered surfaces or they can be man-made architectural components, monuments, or grave stones. Polymer impregnation of the pre-formed porous surface stone is only limited by the size of the impregnating equipment and the ability to move the article to be impregnated. This is, of course, more cost effective for smaller, easily handled articles. The polymer impregnated pre-formed porous stone surface layer acts to preserve the stone article and inhibit the effects of future exposure to weathering. Coloration included in the polymer impregnant composition(5) can also provide an enhanced decorative effect. Also, naturally sculpted stones(22) will be free from friable, crumbly, and gritty surfaces.

Of special importance are two variations of agglomerated polymer impregnated pre-formed porous stone articles of manufacture (FIG. 11 and FIG. 12) that involve the use of pre-assembled porous stones(19), in which the polymer impregnant component(5) also contacts the assembly materials. In both cases, unimpregnated porous stone aggregate(19) is mixed with any medium to high viscosity organic or inorganic pre-assembly adhesive, cement, or matrix composition(20) to fully coat each particle. Curable epoxy resins are most preferred. The impregnant compositions(23) of this invention may be used for this purpose, if viscosity is increased by filler loading or the addition of thixotropic agents. Chopped glass fibers may be added to the composition for additional strength. The mixture is then poured into a mold. Sufficient vacuum is applied to remove some of the excess air, but not so much as to cause any appreciable penetration of the coating or matrix(20) into the porous stone particles(19) after the vacuum is released to standard atmospheric pressure. The filling material(20) may remain in the mold, or may be drained some what to provide a more open aggregate structure. The cast composite is allowed to solidify, and then removed from the mold.

Two different agglomerated impregnated pre-formed porous stone articles can be produced from this assembled composite of unimpregnated porous stone(19). One is a bulk form article (FIG. 11) of any dimension or shape. The other is a planar article (FIG. 12) of a thickness smaller than the shortest dimension of any particular incorporated aggregate particle(19) prior to cutting to the desired thickness.

In a bulk form article (FIG. 11), surfaces are machined to expose the unimpregnated porous stone(19). Then the entire article is impregnated with a fluid polymer composition(23), and solidified or cured. This results in an impregnated agglomerated article wherein the porous stone aggregate(10) at the surface is impregnated with a polymer impregnant(5), while the interior porous stone aggregate(19) contains dead air spaces. The impregnant(5) may or may not extend internally between the spaces of the pre-assembled structure depending upon the amount of filling of the pre-assembly adhesive, cement, or matrix composition(20). In this manner large, lightweight, ornamental sculpture forms having a strong and durable aggregate-appearing shell can be produced. Also, decorative and lightweight structural blocks may be produced in this manner. They will have a certain degree of insulating value because of the enclosed dead air spaces within the internal unimpregnated porous stone aggregate(19) components. Lightweight, highly porous aggregates(19) such as pumice or scoria are preferred. High compressive strength polymer impregnants(5) are preferred. High tensile strength pre-assembly adhesives, cements, or matrix compositions(20) are preferred.

In a relatively flat, thin planar article (FIG. 12), the pre-assembled porous stone casting is sawed into sheets thinner than the smallest dimension of any component unimpregnated porous stone particle(19) prior to impregnation. In this manner, all porous stone particles(19) are exposed on at least one side of the sheet and the sheet is held together by the pre-assembly adhesive, cement, or matrix composition(20). Upon impregnation with a polymer composition(23) and subsequent solidification or curing, a polymer impregnated pre-formed porous stone agglomerated sheet, tile, or panel is formed. This sheet may be cut and trimmed to any shape. Somewhat resilient polymer impregnants(5) and pre-assembly materials are preferred for floor tile applications. In a similar manner, blocks or rough-shaped castings may be cut into curved shapes, such as the wall of a vessel or a lamp shade.

As can be seen by the previous descriptions and examples of polymer impregnated agglomerated pre-formed porous stone articles, many variations are possible and beyond the scope of this description to mention in all entirety. The variations and examples previously mentioned should not be construed as limiting the scope of this invention, but as merely providing representations of this preferred agglomerated embodiment.

A third preferred article of manufacture is either a pre-formed individual (FIG. 13) or an agglomerated polymer impregnated pre-formed porous stone, as previously described, in which the internal composite structure has been partially or fully exposed at the external surface area by any method. The exposed internal structure in some cases, may reveal new visible areas of blind voids(3), resulting from opening up of previously impermeable totally enclosed voids(4). Existing areas of unfilled(8) porosity may also be present. (See FIG. 2 prior to internal exposure). The skeletal framework(1) will also be exposed in this embodiment.

Exposure of the internal composite structure may be by any method including, but not limited to: milling, cutting, slicing, carving, chiseling, routing, drilling, engraving, etching, sand blasting, filing, grinding, sanding, and polishing. The appearance of the internal composite structure may range from a rough texture to a smooth highly polished external surface.

An exposed cross section of the internal composite structure of a polymer impregnated stone provides an entirely new visual dimension to the impregnated stone. Intricate structures that are barely visible in unimpregnated porous stone(22), sand out boldly and impressively in exposed impregnated cross-sections. Surfacing of any pre-formed individual or agglomerated polymer impregnated porous stone article provides a very different and highly decorative appearance. Any of the previous uses of individual or agglomerated polymer impregnated pre-formed porous stones are also included in this preferred embodiment.

Abrasive action that exposes the internal structure also increases the many uses of polymer impregnated pre-formed porous stone articles. By incorporating a polymer composition(5) component that is highly durable and capable of being machined, smooth surfaces with well defined edges are easily produced. Smooth floor, wall, and ceiling tiles or panels of immeasurable beauty can be produced. Poured terrazzo floor takes on a new look. Solid surface counter tops and table tops can be produced with a unique decorative effect. Extremely thin, durable veneers of polymeric stone can be made to accent articles of furniture. Translucent articles of polymeric stone, for use as lamp shades or decorative window panes can be made to brilliantly exhibit the natural beauty of porous rock. Ornamental sculpture can be surface ground and engraved with a high degree of intricate detail. Unimpregnated porous bodies, previously incapable of a smooth surface, can be produced to take a high polish by selecting a polishable polymer composition(5). An entirely new polymeric stone effect can be incorporated into the gemstone jewelry industry.

In some combinations of relatively soft porous stones(22) and flexible polymer compositions(5) very thin veneers can be produced by slicing or shaving a dimensional stock article. These veneers can be adhered to, or laminated to a substrate for use as wall paneling, similar to wood veneer paneling, but with the grain and design of stone.

Any of the preferred embodiments can be further enhanced by any method normally used for finishing plastics, stone, wood, or metal. Finishing methods include, but are not limited to: surface pore filling, dyeing, staining, priming, film coating, electroplating, laminating, waxing, oiling, etching, flame finishing, sand blasting, and additional polishing. Film finishes may be evaporative finishes, reactive conversion finishes, or coalescing finishes. Any exotic finishing variation may be used.

Any newly revealed blind voids(3) of an exposed internal structure (FIG. 14) may be partially or completely filled by a secondary polymer impregnant composition(21). This secondary composition(21) may optionally perform as a coating material of the article. It may be clear or colored; it may be transparent, translucent, or opaque; and it may be of the same or different composition than that of the primary impregnant(5).

Finishing the external surface of any of three preferred articles is considered a fourth preferred embodiment of polymer impregnated porous stone articles, because the finishing processes are essential to produce the maximum enhanced decorative effect to all other embodiments.

### METHOD OF PRODUCTION

The procedure for producing individual or agglomerated polymer impregnated pre-formed porous stones varies somewhat depending upon the particular physical, chemical, and esthetic properties desired in any particular finished product, and upon variations in any of the component materials. For purposes of simplification, a brief listing of the normal sequence of steps is hereby included. This arrangement is presented as a general guide to the overall process. However, since some steps are optional and there can be some overlap between steps, this outline is not meant to be rigidly chronological or conclusive, nor is it meant to be construed that all steps are necessary in the production of different embodiments and variations of polymer impregnated pre-formed porous stone articles.

However, in all cases, a method for forming a polymeric matrix stone composite structure product(10) or singular polymer impregnated stone article (FIG. 16 being an example), (both which include a singular skeletal framework(1) stonelike bulk filler and a solidified polymer polymer or polymer composition(5) matrix) resembling a natural rock in texture, structure, and formation, always includes solidifying a fluid impregnant(23) within the evacuated permeable interstitial spaces of a natural or artificial pre-formed porous stone body(22) and distributing the fluid impregnant(23) in a relatively substantial and consistent manner throughout most of the volume of the permeable interstitial spaces, prior to solidification.

Some description of method has previously been disclosed in examples and variations of the composite structure and articles of manufacture. They are hereby considered to be included as part of the method of this invention.

Briefly, the procedure for forming a decorative and structurally enhanced impregnated porous stone product(10), and the procedure for producing various individual (FIG. 16 being an example) and agglomerated articles, including exposure of the internal composite structure and finishing of any surface, involves the following steps:

1. Pre-forming a porous stone

2. Dehydrating a porous stone

3. Pre-treating a porous stone framework

4. Containment of a porous stone

5. Impregnating a porous stone

6. Solidifying and curing

7. Exposing the internal composite structure

8. Finishing the surface

Step 1. Pre-forming a Porous Stone

Pre-forming a porous stonelike body is a preferred essential step in producing a polymer impregnated stone article. Although any dimensional block of individual or agglomerated polymer impregnated stone can subsequently be made into any shape, pre-forming is preferred as a cost effective measure designed to minimize the amount of polymer impregnant utilized during processing of a completed product, and maximize the shaping efficiency of the end product.

A porous stonelike body has the distinct advantage of being easily shaped due to a relatively fragile framework structure. Any particular shape of an individual porous stone(22) is easily and quickly attained by any dry or wet method of shearing or abrasion including, but not limited to: sawing, grinding, slicing, carving, cutting, sand blasting, and water-jet action. As a comparison, many varieties of natural or artificial porous rock can be shaped as easily as soft pine or balsa wood.

In addition, slices of meltable varieties of porous rock bodies, such as volcanic pumice or scoria, may be thermo-formed at high temperatures. This can be accomplished by gravity or slight pressure at the softening point. Care should be taken so that porosity is not substantially reduced by coalescence due to excessive pressure or high temperature shrinkage.

Small aggregate sizes(22) may be processed by crushing and screening to the desired size. If rounded edges are desired, abrasion can be accomplished with a tumbler.

Larger individual porous stones(22) may be pre-formed to any particular shape. However, design considerations that minimize the bulk volume of porous stone(22) are preferred. Thin shapes and hollowed out larger shapes(22) minimize the amount of polymer impregnant(23) and also reduce the amount of internal stress during thermal expansion and contraction of the polymer impregnated stone product.

However, individual polymer impregnated stone dimensional stock, up to twelve inches thick has been produced, and sawn into tiles without any noticeable impairment. It is currently unknown if such tiles would be affected by internal stress factors over a long period of time. Pre-cutting relatively large tiles or sheets to shape prior to impregnation is therefore preferred.

The natural or artificial porous rocks used in this invention are easily machined due to their open framework structure (FIG. 1). However, the skeletal framework(1) often contains very hard rock and mineral components that will easily abrade hardened steel. Therefore, very hard cutting tools and abrasives are preferred such as tungsten carbide, silicone carbide, and diamond.

Although many porous bodies are quite fragile, they can be machined into dimensional stock or lathe-turned shapes(22) by using high speed cutting and abrasion tools and equipment. For many mass-produceable articles, equipment capable of achieving fairly accurate machining tolerances are preferred. Computer assisted machining operations are favored.

Besides standard stone cutting equipment, most metal working and woodworking equipment can be modified to pre-form individual porous stone shapes(22). Provisions should be made to protect the equipment and the operator from dust, water, mud, and stone chips. Operator safety equipment and exhaust ventilation equipment are strongly recommended.

For safety and extended tool life reasons, wet cutting or abrasion is preferred to dry cutting or abrasion. However, dry cutting or abrasion methods may also be used with adequate ventilation. Only clean water should be used in wet cutting or abrasion. Cutting oils will penetrate the porous body and cannot easily be removed. Also, care should be taken as not to contaminate the porous body with machinery lubricants. Water may be applied as a mist or stream during machining, or the porous body may be pre-soaked in water prior to machining, or both.

Large, quarried, natural porous rocks can be reduced to smaller dimensionally-oriented stock by splitting, wire-sawing, band-sawing, or water-jet action. They can then be machined into any number of shapes using applicable tools and equipment.

Free-form sculptural shapes can be produced by any number of hand or powered tools generally used in the prior art of stone carving and sculpting. High speed disc and die grinders are very effective for fast stock removal. Sculptural shapes(22) should be hollowed out as much as possible. High intensity light transmission through the porous body shell and the use of calipers are useful aids in determining wall thickness. Sculptural forms(22) may also be mass produced from a model by the use of powered duplicating equipment.

Both dimensional stock(22) and free-form sculpture(22) may have an accessory insert (FIG. 10 is an example of one type) or protruding fixture attached to the work piece prior to shaping operations. Such a fixture assists in holding the porous body work piece in a stable position while shaping operations are taking place. The attachment may be removed before, during, or after final processing operations, or may remain as a agglomerated accessory component (FIG. 10). Attachment to the porous body with an epoxy adhesive(18) that will partially penetrate (about one-eighth of an inch in most applications) into some of the porosity is preferred.

For example, a cylindrical blank is cut from a quarried natural porous rock with a core drill; the ends are squared off on a table saw or bandsaw; the intended base of the article to be produced is recessed with a drill; a hole is drilled in the center of the recess; and a metal, internally threaded insert(17) is cemented into the hole with an epoxy adhesive(18). The insert-modified porous stone cylinder is then threaded onto the drive shaft of a lathe. The cylinder can then be turned to any shape, and the work piece can be removed and re-attached to the lathe drive shaft at any time during processing, especially for any final grinding, sanding, or polishing after impregnation.

Agglomerated assemblies of pre-formed porous stone may be bonded together before, during, or after polymer impregnation, but prior to solidification or final curing of the polymer composition. Assembly methods will be discussed as they are implemented throughout each step. For example, the machine attachment insert(17) to assist in pre-forming individual shapes (described in this step) may remain as a pre-assembly agglomerated accessory component.

After the final rough shape of any article has been pre-formed, the surface may optionally be accented by any method including, but not limited to: fine sanding, sand blasting, chemical etching, carving, or engraving. If the interior composite structure is to be exposed at the surface of the article after polymer impregnation, then the pre-formed article should be made slightly oversize. Generally, an excess of one-sixteenth to one-eighth of an inch of porous stone should remain on the surface. This varies depending upon the porosity size and desired effect. The excess will be removed by machining after subsequent impregnation and solidification. The finished surface of articles that are to be re-ground after impregnation and solidification is not as critical as those articles which will exhibit the pre-formed surface after final processing. After pre-forming to a desired shape, the porous stone article is washed with clean water, air dried, and blown with compressed air to remove any excess dust and debris.

It should be noted that while pre-forming is a preferred step in this invention, the pre-forming step can optionally be previously accomplished by nature or another manufacturer. For example, beach gravels of pumice stone are an excellent source of naturally pre-formed aggregate size material. Another example would be pre-formed artificial porous stone which may already be in the shape of a desired article of manufacture. Yet another example would be a natural stone shaped either by natural erosion or man, in which the surface was weathered to a porous permeable shell receptable to polymer impregnation.

Step 2. Dehydrating a Porous Stone

Dehydrating of a pre-formed porous stone(22) is a preferred essential step in producing a polymer impregnated stone article. Internal moisture may contaminate many fluid polymer impregnants(23), and can also inhibit even distribution of any fluid impregnant composition(23) throughout a porous stone(22). Therefore, it is preferred that this moisture be evacuated from the pre-formed porous body(22) prior to impregnation or embedment.

The preferred method of dehydration is by evaporation or vaporization. Either heating, vacuum, or a combination of both may be utilized. Air drying may remove most of the internal moisture over an extended period of time. However, dehydration by drying in a vented oven or vacuum chamber equipped with a moisture indicator or gauge decreases drying time and gives some measure of moisture being released.

After loading an oven with pre-formed porous stone(22), temperature is slowly raised to slightly below the boiling point of water, so that vapors escape slowly. After it appears that most of the moisture has been removed, oven temperature is raised to slightly above the boiling point of water until no moisture is measured in the oven. The heat is then turned off, and the oven is allowed to cool at room temperature. The porous stones(22) are then removed.

Higher temperatures can be applied to some highly porous natural stones(22), especially volcanic varieties, to decrease dehydration time. Experimentation with different drying schedules for any particular variety of porous stone(22) is recommended to attain maximum efficiency. Porosity and moisture retention can vary considerably, even within the same variety of natural porous rock from the same quarry.

Vacuum dehydration can easily be accomplished without any concern of thermal shock. Porous stones(22) are placed in a vacuum chamber and the chamber is evacuated to a negative pressure about 28 to 29 inches of mercury at room temperature. This vacuum is maintained until it appears that most of the moisture has been removed. Negative pressure may then be increased slightly to cause any remaining moisture to boil off. The vacuum is released slowly and the porous stones(22) may be removed immediately.

This procedure may also be accomplished by using a heated vacuum chamber. Of course, a less elevated temperature and a less negative pressure are required to approach the boiling point of water.

Step 3. Pre-treating a Porous Stone Framework

Pre-treating (FIG. 3 and FIG. 4) a porous stone skeletal framework(1) before or after pre-forming to a desired external size and external shape is a preferred alternate step designed to incorporate additional decorative or structural qualities into a polymer impregnated pre-formed porous stone (as shown in the examples of FIG. 3 and FIG. 4). Many variations are possible, but they all include contacting and/or reacting a substantial portion of the porous stone skeletal framework(1) with any other matter prior to impregnation of the porosity with a fluid polymer composition(23). Several examples are described in this step, but they are not meant to limit the number of possible variations or any combinations thereof.

Decorative pre-treatment of the skeletal framework(1) may include, but is not limited to: precipitating a dye or pigment; applying a dyed, pigmented, or metallized film coating(9); and reaction with a bleaching agent or etching agent. Electroplating of a pre-treatment conductive coating is also possible by electrolysis of a subsequently impregnated electrolyte solution. The pre-treated porous stone (FIG. 3) should be completely submerged during electrolysis.

Structural pre-treatment of the porous stone framework(1) may include, but is not limited to: coating with a primer, coating with a thermal expansion buffer, and bonding with a coupling agent. Dyes, pigments, or finely powdered metals also may be mixed into structural pre-treatment coating materials.

Dyeing and pigmenting the skeletal framework(1) provides for a more diversified range of color contrast between the framework structure and a colored polymer impregnant. Also, grain patterns within the porous stone are intensified in areas of the smallest porosity. These areas have a considerably greater internal surface area per unit volume of porous stone. Hence, more coloration will be deposited in higher density micro-porous areas of the porous stone. Pigments should be of the finest size available, so that settling is minimized. In all cases, light fast dyes and pigments are preferred.

Bleaching the skeletal framework(1) expands the possible color range by providing a lighter colored framework(1), or a framework(1) that can subsequently be pre-treated with lighter pastel colors.

Etching the skeletal framework(1) increases the porosity of any given porous body and changes the interior wall surface texture of the skeletal framework(1). This produces a slightly different decorative visual effect.

Primers and coupling agents provide stronger bonds between the stone framework(1) and the solidified polymer impregnant composition(5). Primers can usually penetrate a porous stone(22) more thoroughly than some polymer impregnants and thus provide a greater mechanical bond. Specific primers should be compatible with any particular polymer impregnant for optimum bonding. Coupling agents provide chemical bonding between both the stone framework(1) and the polymer composition(5). They should be selected based upon the chemical structure of the particular chosen combination of porous stone(22) and polymer composition(5).

Thermal expansion buffers are usually somewhat flexible coatings(9) that bridge the differences in thermal coefficients of expansion between a porous stone skeletal framework(1) and a solidified polymer impregnant composition(5). They assist in reducing separation of the void filling component from the stone framework.

A preferred method for pre-treatment of a porous stone skeletal framework(1) includes dissolving or suspending a pre-treatment material in a low viscosity solvent or liquid; saturating most of the void spaces of a porous stone with the solution or suspension by wet vacuum impregnation; and then evaporating or vaporizing of the solvent or liquid. This method may be repeated as often as necessary if individual pre-treatment measures cannot be combined into one operation.

The amount of solid pre-treatment material dissolved in a solvent or suspended in a liquid should be quite low, in order to minimize clogging of the smaller void spaces. Clogging of the porosity may restrict evaporation of the liquid, and also may restrict subsequent impregnation of the subsequently distributed fluid polymer(23) or polymer forming composition impregnant(23). The amount can be varied depending upon the porosity of any particular porous stone(22), but generally should be less than ten percent by weight of the pre-treatment fluid(23). Experimentation on any particular porous stone(22) is recommended to achieve maximum results. Bleaching and etching solutions(23) should be diluted to minimize rapid escape of volatile reaction products. Rapid escape of vapors can prematurely force a solution out of a porous stone and reduce the reaction effect of a bleaching or etching agent. The pre-treatment fluid(23) is another form of an impregnating fluid(23) and the methods of pre-treatment and impregnating are similar in many respects. Therefore, the description of both methods is included herein.

Wet vacuum impregnation involves evacuating most of the air from a porous stone that is completely submerged in the pre-treatment solution or suspension(23) under vacuum. Under the influence of gravity, the fluid(23) will begin to penetrate the porosity as the air is displaced. When the vacuum is released, standard atmospheric pressure will force the fluid(23) throughout most of the porosity. Additional pressure may be applied, but generally is not necessary with extremely low viscosity fluids(23). Also, more time and energy may be involved in evaporation or vaporizing the liquid from fluids(23) that have been highly pressurized into the micro-porosity.

The procedure for wet vacuum impregnation is relatively easy, and many pre-formed porous stones(22) can be batch processed to facilitate an efficient operation. If threaded machining inserts(17) are present in a pre-formed porous stone(22), the threads should be protected prior to processing with a temporary release agent, film coating, or removable plug.

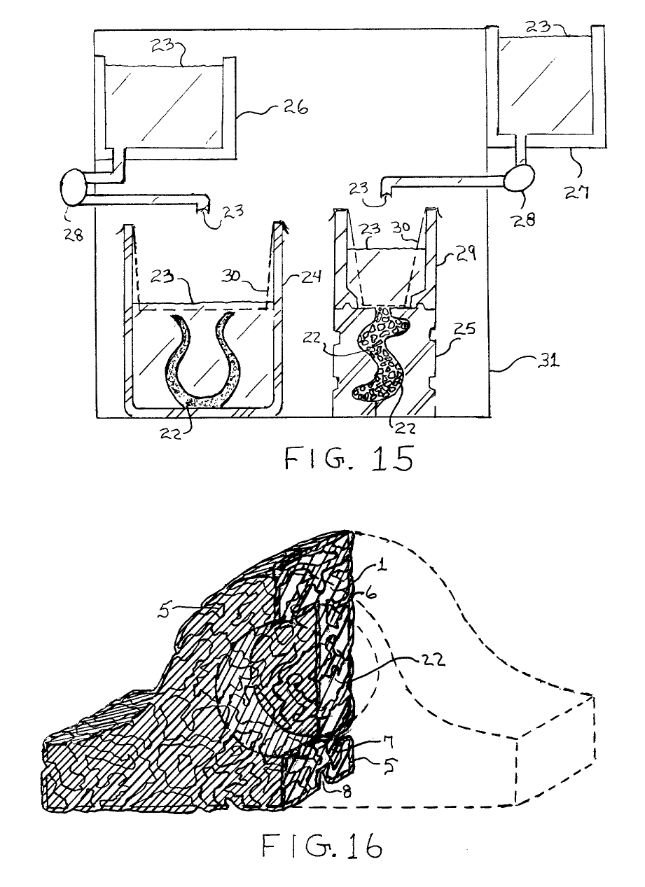

Pre-formed porous stones(22) are placed in a containment vessel(24) or vat and completely covered with the pre-treatment fluid(23) (FIG. 15). Sufficient fluid(23) must be present to assure that the porous stones(22) are completely submerged throughout the pre-treatment process. The container(24) should be non-reacting to the pre-treatment fluid(23). The container(24) should be only partially filled with porous stone(22) and fluid(23) so that allowance can be made for bubbling, foaming, and spattering during air evacuation. The container(24) should be fitted with a removable perforated or screened lid(30) or weighed attachment that is recessed below the surface of the liquid(23) and in contact with the porous stones(22). Many porous stones(22) will float in a liquid due to large percentages of trapped air. It is important that they be kept submerged during impregnation to insure maximum penetration and even distribution of the pre-treatment fluid(23). The containment vessels(24) or vat may also be fitted with a pump or agitation device to minimize settling of suspended pre-treatment materials.

The container(24) of pre-formed porous stones(22) and pre-treatment fluid(23) is placed in a vacuum chamber or combination vacuum/pressure chamber(31). The chamber itself may be designed as a containment vessel(24) for use in continuous batch processing of the same pre-treatment fluid(23). Air is evacuated from the chamber and the porous stones(22) by applying a vacuum approaching one atmosphere of negative pressure or about 29 inches of mercury. Boiling of the liquid(23) under vacuum can inhibit porosity penetration and should be kept at a minimum by selecting liquids or solvents of sufficiently high vapor pressures or by cooling the pre-treatment fluid(23), the container(24), and the vacuum chamber prior to and during the vacuum impregnation process.

The vacuum chamber should be equipped with a viewing window so that bubbling of air evacuated from the porous stone can be observed. When bubbling ceases or becomes minimal, the vacuum can be released to standard atmospheric pressure. The contained porous stone(22) and pre-treatment fluid(23) should be allowed to set for several minutes to reach equilibrium.

However, if additional pressure is desired, it can be applied immediately in a combination vacuum/pressure chamber(31) in the form of dry compressed air or inert gas. If the pressure is to be held for any lengthy period of time, then the contained porous stone(22) and pre-treatment fluid(23) may be transferred to a separate pressure vessel for processing. Additional pressure may be necessary in some bleaching and etching solutions(23) that produce gaseous by-products. Both additional pressure and cooling during pressure can reduce rapid effervescence and still allow the reaction to proceed. Pressure build-up during the reaction should be monitored with a pressure gauge. Pressure should be released very slowly after the reaction is complete, or bled off slowly if the pressure level approaches the maximum safety level of the pressure vessels.

Porous bodies that have been pre-treated with a reactive agent, or those that will include a precipitated powder or dye as a result of the pre-treatment, should be internally rinsed to minimize contamination of subsequent impregnating fluids or polymer impregnants(23). Rinsing involves removing the porous stones(22) from the pre-treatment bath; rinsing the surface with a compatible liquid; placing the porous stones(22) in clean liquid and subjecting the impregnated pre-treatment fluid(23) to several repeated cycles of applied vacuum and return to normal atmospheric pressure. The clean liquid may be replaced and the rinsing cycle repeated as many times as desired. In this manner, most excess liquid reactants can be removed, and also excess dye and pigment can be removed. Sufficient dye and pigments will remain in much of the micro-porosity. Internal rinsing is not required in pre-treatment fluids(23) designed to deposit a film coating(9) on the porous stone framework, or in those designed to deposit dyes or pigments with added mordents or fixatives.

Evaporation or vaporization of a pre-treatment fluid(23) will deposit a powder or film coating(9) in contact with most of the skeletal framework(1) of a porous stone(22). This procedure is carried out in a manner very similar to the dehydration procedure. Air drying, heating, or vacuum drying may be used. Since volatile solvents are generally used to reduce most film coating materials, it is recommended that flash points be observed and appropriate ventilation measures taken when heating flammable volatile solvents.

Boiling points of any pre-treatment fluid(23) must be taken into consideration. Boiling points must not be exceeded in any method of evaporation or vaporization, or the pre-treatment fluid(23) will be forced out of the porous stone(22). After most of the solvent or liquid has been removed, the boiling point may be slightly exceeded to remove final traces of the solvent or liquid, provided this measure does not adversely disturb the precipitate or coating(9). If long term heating degrades the applied precipitate or coating(9) then vacuum drying is strongly recommended.

In many cases involving pigments and coatings(9), it is necessary to rotate the porous stone(22) during the evaporation or vaporization procedure. This assures a more even distribution of the pre-treatment fluid(23). Low RPM mechanical rotation about a horizontal axis is generally sufficient. However, multi-axial rotation similar to that used in the plastic industry for rotational molding provides a more even internal distribution. Examples of multi-axial rotation devices are illustrated in Van Nostrand Reinhold's “Plastics Engineering Handbook”. Speeds of rotation are generally less than 15 revolutions per minute. Attachment to the rotation device may be by any mechanical means. For example, individual treated articles with threaded inserts(17) may be directly threaded on a rotational shaft coated with a release agent. Alternatively, the rotational shaft may be fitted with an expandable collet that can be inserted into a pre-formed recess in the porous stone(22). Another example would be a rotating cage designed to clamp and hold one or more porous stones(22). Small individual treated aggregate particles can be rotated in a perforated barrel partially filled with aggregate and rotated slowly enough not to cause substantial surface abrasion upon the particles.

If rotation is necessary or desired, the shaft of the rotation mechanism must be located within the drying oven or vacuum dryer. A live-center mechanism similar to the tail stock of a lathe may be located opposite to the rotation shaft to clamp the treated porous stone article to help stabilize the weight during rotation. After thorough drying, the pre-treated porous stones are ready for containment prior to polymer impregnation.

It should be noted that coating of the porous stone skeletal framework(1) can be of benefit in pre-forming extremely fragile porous bodies. Consolidation and strengthening of a very weak framework(1) allows for producing finer detail and thinner shapes. In these cases, the porous body is only very roughly shaped to its desired form, the skeletal framework(1) is pre-treated with a machineable coating similar to the coating(9) of FIG. 3) to improve consolidation, and the porous stone is then re-machined to a pre-formed shape.

Another preferred method for pre-treatment is to contact the porous stone skeletal framework(1) with a vapor that sublimates to a solid upon contact with the framework(1). This may be done by vapor deposition of metals, plastics, carbon, and other solid materials under vacuum of extremely high negative pressure. This method has not been fully tested, but is mentioned as a matter of record.

It has been discovered in developing polymer impregnated pre-formed porous stone that pre-treatment of a porous stone(22) with some coatings(9) can produce another variation of decorative and structurally enhanced porous stone. By the same methods described for pre-treatment of pre-formed porous stones(22), another variation of a preferred individual polymer impregnated pre-formed porous stone article can be produced. The third preferred composite structure is that of a pre-formed(22) and pre-treated porous stone that has a film coating of fluid impregnant(23) deposited upon most of the interior walls of the skeletal framework(1) in a uniform manner prior to solidification of the fluid impregnant(23) as a polymer or polymer composition(5) film coating(5). FIG. 3 is an example.

Any fluid polymer or polymer forming composition that produces a structural coating(9) may be utilized at about ten percent of the pre-treatment fluid(23) by weight. Dyes, pigments, or metallic powders may be added. The coating(9) may also be electroplated. Epoxy resins are preferred, especially long term pot life epoxy resins.

The uses of this product are much more limited, because of its lower strength as compared to individual polymer impregnated pre-formed porous stones with substantial fillings. However, the polymer composition cost is substantially reduced.

Uses include, but are not limited to: ornamental sculpture, some decorative architectural applications where strength and wear resistance are not a major factor, as a container for live or artificial plants, as a landscape rock, and for novelty decorator items.

Step 4. Containing a Porous Stone Article

Containing a pre-formed porous stone(22) and a fluid polymer or polymer forming composition(23) in a vessel(24) or a mold(25) is a preferred and necessary prerequisite step to impregnation of individual and agglomerated articles. Vessel containment and mold containment perform different functions depending upon the desired resultant surface effect of the polymer impregnated stone; the physical properties of the fluid impregnant composition(23); the length of time that it takes to solidify or cure the polymer composition(5); and whether or not the article is to be agglomerated during the impregnation and/or solidification process. Containment and impregnation are integrally related. Therefore, there may be some overlap between this step and the next.

Vessel containment has previously been described in impregnation with a low viscosity pre-treatment fluid(23). A similar vessel(24) or vat is used in a vacuum/pressure chamber(31) impregnation (FIG. 15) with a fluid polymer or polymer forming impregnant composition(23). It must be thermally and chemically non-reactive to the impregnant composition(23); be deep enough to allow for boiling, foaming and spattering, and have a weighted attachment or perforated recessed lid(30). It may also be fitted with an agitation device or pump to inhibit settling of any dense material incorporated into the fluid impregnant(23).

Vessel containment is a very efficient continuous batch process system and requires that impregnated articles be removed from the vessel(24) prior to placing more porous stones(22) in the vessel(24) for the next batch. Upon removal from the vat(24), excess impregnant(23) will partially drain from the surface and from the exposed surface porosity. This will produce an article with a textural surface with unfilled or partially filled textural porosity depending on the degree of containment during solidification or curing. Containment by horizontal or multi-axial rotation will reduce the gravitational draining effect and partially retain the impregnant in the textural porosity until it becomes solid.

Vessel containment is limited to the use of low viscosity polymers or polymer forming compositions(23) that can remain stable and highly fluid at a given temperature range over an extended period of time. Groups of individual articles can be batch processed quite easily in large vats. Vessel containment of agglomerated articles is generally limited to those pre-formed porous stones(1) that have been pre-assembled with an adhesive bond or mechanical connection.

However, agglomerated articles may be produced by assembly after vessel containment impregnation, wherein the impregnant(23) acts as an adhesive and matrix. For example, a batch of impregnated aggregate may be transferred or poured into a mold(25) and allowed to become solid. Also, perforated molds can be used to produce open structured agglomerated aggregates (FIG. 6) by impregnation of the filled perforated mold within a containment vessel(24) and draining, or by filling the perforated mold with aggregate that has been previously impregnated in a containment vessel(24) and then draining. Thus, a cast agglomerated polymer impregnated pre-formed porous stone article is produced using vessel containment of agglomerated components during the impregnation step. In this manner, the pot life of the impregnant(23) can be substantially reduced, since the vessel(24) is being completely emptied between batches. Polymer impregnated stone terrazzo flooring can be produced by this method. An uncured impregnated pre-formed porous stone aggregate mix may be combined with a synthetic resin based matrix, poured into a substrate, allowed to cure, and ground smooth.

Mold containment is significantly different than vessel containment. Molds(25) can be designed and constructed in any manner consistent with the prior art of mold making. They may be reusable molds or one-time throw away molds. However, certain provisions must be made for use in processing polymer impregnated pre-formed porous stone articles.

The mold material must be non-reactive to the impregnant composition(23) and capable of withstanding all temperatures and pressures encountered during impregnation of the porous stone(22) and solidification or curing of the impregnant composition(23). The mold surface that will be in contact with the impregnant composition(23) may be treated with a mold release agent to facilitate easy removal. The release agent used should not contaminate the impregnant composition(23) to any appreciable extent.

A mold(25), as used in this invention, is generally considered a vertical container, (see FIG. 15). All openings at the top of the mold(25) should be at the same level and sufficiently above the top surface of the contained impregnant(23). An overflow chamber(29) at the upper portion of the mold(25) will allow for bubbling, foaming, and spattering. The overflow chamber(29) may be an integral part of the mold(25) or it may be detachable. If detachable, a leak-proof seal should be provided. A removable perforated or weighed attachment(30) to prevent floating of the pre-formed porous stone(22) may be included. The mold(25) may have an external attachment device for connecting to a rotation mechanism used during solidification or curing. Also, the mold(25) may have a fitted cover to be attached after fluid impregnation if rotation is desired during solidification or curing.

If the mold(25) is used to contain an individual or pre-assembled porous stone(22) it should be slightly oversize to allow impregnating fluid(23) to be more accessible to most of the surface area. One-sixteenth to one-eighth of an inch away from the surface is generally sufficient. Nubs or small protrusions may be incorporated onto the interior mold surface if desired to keep most of the porous stone(22) from having major contact with the surface of the mold(25) and allowing more efficient flow of the impregnating fluid(23). In another variation, a clear gel coat(16) may be solidified on the smooth surface of a containment mold(25) prior to filling the mold with porous stone(22) and impregnant fluid(23). Mold containment during solidification provides for the most complete filling of the permeable textural porosity and also provides a surface to the polymer impregnated stone dictated by the surface of the mold.

Containment of a mold(25) is part of an individual casting process, and as such, much smaller prepared quantities of a fluid polymer or a polymer forming composition are needed in the fluid impregnant(23) for each separate impregnation. However, several molds(25) may be filled and impregnated at the same time. Smaller pre-measured quantities of fluid impregnant(23) allow the use of polymer forming compositions that cure quicker, and the use of molten polymers that have shorter heat-degradation time periods. Impregnating fluids(23) can have somewhat higher viscosities if they are introduced into an evacuated, fully enclosed containment mold(25) under pressure, as in vacuum/pressure casting.

Mold containment is generally employed throughout both the impregnating and solidification steps. However, a mold(25) may also simply act as a containment vessel(24) when impregnating small batches of a single individual or pre-assembled agglomerated porous stone(22). The impregnated article can be removed from the mold(25) prior to solidification in order to produce a textured porous stone surface on the solidified article.

As a comparative example, an assembled shallow rectangular box, such as a jewelry box, can be produced using the same mold to produce different surface textures. In one case, the pre-formed sides and bottom of the box are pre-assembled with a cement or adhesive. The assembled box is additionally ground or sanded to produce smooth joints and remove any cement or adhesive. The assembled box is placed in a closely fitted deep rectangular tray mold. Another smaller, deep rectangular tray mold is closely fitted in the inside of the pre-assembled box. A weight is placed inside the interior tray. The space between the interior and exterior mold is partially filled with impregnant(23). The mold acts as a containment vessel(24) during the impregnation step. After impregnation, the box is removed; impregnant(23) is allowed to drain off the surface; and the article is solidified. The result is an impregnated agglomerated article with a textural surface.

In another case, the pre-formed sides and bottom of the box are placed unassembled between the exterior and interior rectangular shaped trays. The pre-formed porous stones(22) are held in place by this containment mold(25). Temporary spacers are clamped between the walls of the interior and exterior tray. They are located so that they touch the top surface of the pre-formed side panels of the box to prevent floating of the porous stone(22) during impregnation. After impregnation, the spacers are removed, but the mold(25) remains, containing the (impregnated) porous stones(22). During solidification in the mold, the sides and bottom of the box become integrally bonded by the solidified polymer composition(5). The mold is removed and the surface of the agglomerated article exhibits the interior surface of the containment mold(25).

As can be seen from the above description, vessel containment and mold containment produce different finished product results. Also, mold containment increases the variety of fluid polymers and fluid polymer forming compositions that can be utilized as impregnating materials in a fluid impregnant(23).

Step 5. Impregnating a Porous Stone

Application of the principle of forced fluid flow impregnation is required for the introduction of fluids into porous stone. Forced fluid flow is defined as any externally applied force exerted upon a fluid to increase the mobility of the fluid. This increased mobility allows for a more rapid and more complete transport of a fluid material throughout the voids, pores, cavities, vugs, channels, vesicles, fissures, cracks, and other interstitial spaces that typically occur in porous stone. A fluid material can also act as a transport medium for solid particulate matter.

Impregnation of porous stonelike body, or embedment of a porous stonelike body, as it applies to this invention, involves the maximum possible replacement of entrapped air or gas with a relatively low viscosity polymer composition or polymer forming composition as a fluid impregnant(23). Maximum contact with most surfaces of the interior structural framework(1) adjacent to the permeable interstitial spaces is desired to produce a high quality end product. Any method of forced fluid flow impregnation may be used, provided it evenly distributes material throughout a pre-formed porous stone(22).

However, the complex non-homogenous structural nature of many differing varieties of porous stone bodies necessitates the use of a common method that can be applied to any particular porous stone(22) or group of porous stones(22). The preferred and essential method involves utilizing the opposing forces of applied vacuum and applied pressure to transport fluid materials and suspended solids throughout a porous stone(22). Either vacuum/pressure impregnation of a fluid polymer or polymer forming composition impregnant(23) throughout a pre-formed porous stone(22). Although simple immersion of a highly porous stone in an ultra-low viscosity polymer composition impregnant(23) can sometimes produce a similar product, vacuum/pressure impregnation or casting is preferred as the most effective and efficient method. Containment of the impregnant(23) and the porous stone(22) by a vessel(24) or mold(25) during the process is also essential to this method.

Vacuum/pressure impregnation equipment is commercially available. Impregnation chambers(31) and low viscosity polymer impregnating formulations(23) are used to seal the porosity in sintered metal articles, porous metal castings, and porous ceramics. Impregnation chambers(31) can be customized for usage over a wide range of vacuum, pressure and temperature. This equipment and the associated prior art methods can be readily adapted to most impregnating applications as they relate to porous stone bodies involving both vessel containment and mold containment. Separate vacuum chambers and pressure chambers may also be employed to produce similar results. Examples of impregnating equipment that can be used in this invention are described in U.S. Pat. Nos. 4,196,231 and 4,620,991. Several commercial suppliers are listed in the “Thomas Register”.

Vacuum vented pressure casting equipment is commercially available for liquid injection molding or liquid resin molding. This equipment is generally used in the electronics industry for potting or encapsulating electronic components within a containment mold(25). This equipment and the prior art method can also be adapted to porous stone impregnation in a containment mold(25). In this equipment, the containment mold(25) itself acts as a vacuum/pressure vessel, and the impregnant(23) is introduced into the containment mold(25) under pressure. Slightly higher viscosities and shorter curing times may be employed. Many examples of pressure casting equipment may be found in Van Nostrand Reinhold's “Plastics Engineering Handbook”.

The preferred method of vacuum/pressure impregnation (see FIG. 16) can include either dry vacuum, wet vacuum, or a combination of both. In dry vacuum, air is evacuated from a pre-formed porous stone(22) prior to complete submersion in a fluid impregnant(23) composition. In wet vacuum, air is evacuated from a pre-formed porous stone(22) after complete submersion in a fluid impregnant(23). In a combination of both, air is first evacuated from a pre-formed porous stone(22) for a period of time; the pre-formed porous stone(22) is then submerged in the fluid impregnant(23); and air continues to be evacuated with the stone(22) remains completely submerged. Different porous stones(22) and different impregnant compositions(23) respond slightly differently to any choice of applied vacuum but the end results usually appear to be the same. For example, some impregnant compositions(23) may produce excessive bubbling or foaming during wet vacuum of some highly porous stones(22). This foaming can be reduced by dry vacuuming the porous stone(22) prior to submergence in the impregnant(23).

Therefore, a fluid impregnant(23) can be introduced into the containment vessel(24) or containment mold(25) before or after vacuum is applied, from an internal(26) or external(27) reservoir. The impregnant fluid(23) should be vacuum degassed as much as possible prior to contact with the pre-formed porous stone(22). It is important that the pre-formed porous stones(22) remain completely covered with an excess of fluid impregnant(23) prior to slowly releasing the vacuum to normal atmospheric pressure. The procedures are similar to the impregnation of pre-treatment liquids(23), except that applied pressure is essential in this step.

If threaded inserts(17) are present in a pre-formed porous stone, the threads should be coated with a release agent or some form of protection prior to any contact with a fluid impregnant(23). Dehydrated pre-formed porous stones(22) and any assembled components are placed into a mold(25) or a vessel(24) and held in place by a recessed perforated cover or a weight(30).

If wet vacuum is to be used, the vessel(24) or mold(25) container may be partially filled with sufficient impregnating fluid(23) to cover the pre-formed porous stone(22) and allow for displacement of the enclosed air spaces. The vessel(24) or mold(25) container (or several containers) is placed in a vacuum chamber or vacuum/pressure impregnating chamber(31). Vacuum is applied to evacuate most of the air from the pre-formed porous stone(22) and the chamber(31). Light vibration of the containment vessel(24) or mold(25) is also advantageous in some cases. If dry vacuum is used, impregnating fluid(23) is introduced into the container(24,25) after vacuum is applied. It may be introduced from a reservoir within(26) the chamber or from a reservoir outside(27) of the chamber through an in line valve(28).

In vessel containment, an alternative method of dry vacuum may be employed. The pre-formed porous stones(22) can be enclosed in a perforated cage located within the chamber(31). The cage and porous stones(22) are lowered and submerged into a vessel(24) containing a fluid impregnant(23), following the application of dry vacuum. The vacuum/pressure chamber(31) can itself be the containment vessel.

After slow release of vacuum, pressure is applied. Although atmospheric pressure alone may be sufficient in some cases, additional pressure is preferred for maximum penetration. Pressure may be in the form of dry compressed air or an inert gas. After a sufficient period of time pressure is slowly released. Pressure may be introduced into the vacuum/pressure chamber(31); or the impregnated stone, impregnating fluid(23), and container may be transferred to a separate pressure chamber for processing. If desired, mold contained articles may remain under pressure during curing or solidification.

Alternatively, pressure may be applied by centrifuging a contained pre-formed porous stone(22) and fluid impregnant(23) after vacuum has been released. This may also be done simultaneously during wet vacuum in a manner similar to the prior art of centrifugal vacuum casting of molten metals. There are limits imposed by any variation involving centrifugal force. If the impregnating composition(23) is not sufficiently homogenous, differential settling will occur, resulting in stratified layers throughout the porosity. This can be a decorative effect if the settling does not impair solidification of the impregnant(23). Incomplete curing may result in some polymer forming impregnant compositions(23) if the applied centrifugal force is elevated to a substantially high magnitude, because of separation of different density fluid components.

Pre-formed porous stones(22) that have been vacuum/pressure impregnated in a vessel(24) are removed from the vessel(24) to be solidified or cured. The remaining fluid impregnant(23) in the vessel(24) may be used in the next batch of porous stones(22). Pre-formed porous stones(22) that have been vacuum/pressure cast in a mold(25) may remain in the mold during solidification or curing. Any excess fluid impregnant(23) in the mold(25) may be siphoned off to be used in the next batch.

Vacuum and pressure valves can vary depending upon the particular combination of porous stone(22) and fluid impregnant composition(23). Generally, vacuum to remove entrapped air should closely approach a negative pressure of one atmosphere or approximately 29 inches of mercury and be held for several minutes. However, ultra high negative pressures approaching 2 torrs may be used to lower the evacuation time, and remove slightly more air, provided excessive volatization of the impregnant composition(23) does not adversely affect the resultant product. If excessive volatization occurs, lower operating temperatures are recommended to reduce the vapor pressure of the fluid impregnant(23). Applied pressures of approximately 80 to 120 psi held for several minutes are generally satisfactory for most low viscosity impregnants(23). However, higher pressures for slightly higher viscosity impregnants(23) may be utilized if applied slowly. The maximum allowable pressure is at the point that the porous stone framework(1) fails. This can vary considerably among the many varieties of porous stone bodies.

Vacuum/pressure casting with vacuum vented pressure casting equipment has not been tested. However, it is believed that similar results can be attained by using a reusable containment mold(25) as a vacuum/pressure chamber(31) in this equipment. The only difference is that dry vacuum is always used prior to impregnation, and that the fluid impregnant(23) is injected into the porous stone(22) filled containment mold(25) under pressure. Pressure is maintained until impregnation is complete. Pressure may be continued during curing or solidification of the impregnant composition(23). In this manner, a slightly higher viscosity and a much shorter pot life of the fluid impregnant(23) may be utilized.

Other equipment for vacuum/pressure impregnation or casting may be available. However, any equipment currently available or designed in the future that can provide for evacuation of air from a pre-formed porous stone(22), total submersion of the porous stone by surrounding fluid impregnant(23), and pressurization applied to the fluid impregnant(23) to produce a polymer impregnated stone product, can be used in this invention.

Many of the fluid polymeric impregnants(23) used in this invention are currently used for general casting, pressure casting, sealing of porous metals and ceramics by vacuum impregnation, potting and encapsulating of electronic components, liquid resin molding, and embedding of biological specimens.

Any of the ordinary or exotic additives and modifiers used in the prior art of polymer formulation may be incorporated into the fluid impregnant(23). Any future polymer formulations capable of being impregnated into porous stone are also included as the fluid(23) of this invention.

A preferred fluid impregnant composition(23) includes a relatively high concentration of a molten thermoplastic polymer, a polymerizable liquid, a polymerizable solid that can be made liquid, or any compatible combination of these fluids. Low viscosity liquid polymer forming materials are the most preferred. However, not all advantageous fluid impregnants(23) occur in this form. Therefore, other relatively low viscosity forms are also preferred.

Molten thermoplastics may have previously formulated dyes, pigments, plasticisers, modifiers, and additives incorporated in their formulations. They may also be modified in their molten state by any method consistent with their prior art, such as with a plasticizer to produce a plastisol, or with additional colorants.

Polymer forming materials may include, but are not limited to: monomers, catalysts, resins, hardeners, co-polymers, and pre-polymers. They may be combined with compatible dyes, pigments, plasticisers, extenders, reactive diluents, coupling agents, and other additives or modifiers. Polymerization reactions that give off a minimal amount of volatile by-products are preferred. However, pressurization during curing can minimize vapor expansion prior to solidification. Finely ground or powdered fillers may be added. They may include, but are not limited to: talc, calcium carbonate, quartz, glass, and clay. Percentages of added fillers vary depending upon the porosity of any particular porous stone body. Experimentation is recommended for the best results.

Many examples of components of the solidified polymer compositions(5) have previously been listed in the description of the composite structure components, and are herein included as their molten or polymer forming counterparts in the preparation of the fluid impregnant composition(23).

Low viscosity impregnant compositions(23) are preferred for maximum and thorough impregnation. The lowest possible viscosity is always preferred. Therefore, several suggestions are herein described. Many low viscosity formulations(23) can be purchased for use as casting, potting, encapsulating, impregnating, and embedment resins. Special formulations(23) can be made by many chemical manufacturers or by anyone skilled in the prior art of polymer formulation. These formulations(23) can be used as is, or modified to lower their viscosity by such additives as reactive or non-reactive diluents, low viscosity extenders, low viscosity plasticizers, or cross-linking solvent. It should be noted that highly volatile solvents that do not cross-link with the polymer reaction should be kept to a minimum. They are time consuming to remove from the pre-formed porous stone(22) after impregnation and will weaken the final product if allowed to remain during solidification. However, high concentrations of volatile liquids or solvents removed prior to solidification are necessary for producing a film coated(9) skeletal framework(1) preferred composite product.

Somewhat higher viscosities may be used if any particular desired polymer composition is not available or attainable as a low viscosity fluid(23). Also, some what higher viscosities may be desired in vessel containment impregnation of porous stones(22) with a higher concentration of large textural-porosity. This will reduce draining during solidification or curing. The upper limit of viscosity is determined in two ways. If the viscosity is so high that it impairs substantial impregnation throughout the porous stone(22), then a lower viscosity impregnant composition(23) must be used. If the viscosity is so high that entrapped air cannot be substantially removed by vacuum, then a lower viscosity impregnant composition(23) must be used. Therefore, the upper limit of viscosity can vary considerably.

Elevated temperatures are, of course, necessary to reduce a solid thermoplastic composition to viscous state impregnating fluids(23). Heating can also lower the viscosity of polymer forming materials. Blending with compatible lower viscosity polymer composition is another alternative.

Added particulate matter such as pigments, powdered metals, or fillers should be kept at a minimum and be of a size small enough to assure relatively even distribution. However, highly porous stone bodies that can accept larger amounts and larger sizes of particulate matter.

Heating of the porous stone(22) and its container(24,25) can also reduce the viscosity of the impregnating fluid(23). It is always preferred to heat the porous stone(22) and container(24,25) to a similar temperature if the impregnant(23) has been heated. It is also preferred to maintain this temperature within the impregnating or casting equipment(31).

Molten polymer impregnating compositions(23) and liquid polymer forming impregnant compositions(23) that have a pot life greater than eight hours are generally preferred for vessel containment impregnation. However, many commercial impregnating fluids(23) have a latent heat-activated catalyst, and can remain stable for many months. They are always most preferred for vessel containment, provided they produce the desired results in any particular porous stone(22). Short pot life is generally preferred for mold containment. However, enough time should always be allowed for thorough impregnation throughout the porous stone(22).

Step 6. Solidifying and Curing

Molten polymer impregnants(23) are solidified by hardening from a molten state during cooling. Relatively slow cooling is preferred so that any shrinkage is inward with respect to the porous stone(22). Impregnated articles should be removed from the containment vessel(24) or removed with the containment mold(25) and then transferred to an oven. Temperature should be slowly reduced back to room temperature. Cooling schedules vary, depending upon the particular thermoplastic impregnant composition(23) and the thickness of the (impregnated) porous stone(22). For example, low shrinkage compositions impregnated into thin walled porous stone shapes(22) can be cooled at a more rapid rate. Experimentation is recommended for best results.

Polymer forming impregnant compositions(23) cure by chemical reaction to form solid materials within the filled porosity. These reactions may be initiated by incorporated catalysts or hardeners, heat, or radiation. There are many variations in curing times, as those familiar with the prior art can appreciate. Increases in the amount of catalyst, the degree of temperature, and the intensity of radiation accelerate curing time. Some reactions can produce excessive heat. If not dissipated, an exotherm reaction results, and excessive heat is produced that can adversely effect the solidified polymer composition(5). This can be avoided by cooling in order to slow the reaction, or designing thinner articles of manufacture in cases where exotherm reactions are a factor. Some reactions do not cure well in air and should be cured in an inert environment.

Other polymerization reactions generate very little heat of reaction and may take weeks to cure at room temperature. These are excellent choices for vessel containment processing, and impregnating thicker bulky articles of manufacture. Such long-term polymer impregnant compositions(23) can be cured in less than twenty-four hours in most cases with higher temperatures or radiation.

Solidification or curing may produce different internal and external results on the polymer impregnated pre-formed porous stone, depending upon the orientation and degree of draining during curing. Vessel impregnated porous stones(22) may be removed from the vessel(24) and set upright to drain on a releasable grid surface, or lightly centrifuged to remove excess impregnant(23) prior to solidification or curing. The centrifuging will tend to produce a more open textured surface, and a higher concentration of unfilled textural-porosity at the surface of an article. In many cases, a matte finish is produced with a minimal amount of glare. Mold contained impregnated pre-formed porous stones may be cured within the containment mold(25) with or without draining.

If an upright article has a long term cure polymer composition impregnant(23), then heavier pigments and particles will settle in the void spaces, giving a somewhat stratified visual effect. Fast cure impregnant compositions(23) will usually solidify before settling occurs, and will produce a more uniform appearance.

Settling of particles in long term impregnant compositions(23) can be offset by rotation of the impregnated article until the polymerizing impregnant composition(23) gels. Also, additional impregnant(23), or a compatible polymer forming composition can be poured over the article during rotation to provide an integrally bonded coating. Also, mold contained articles with long term impregnant compositions(23) may be capped with a close fitting lid and rotated. Rotation may be about a single horizontal axis or about simultaneous multiple axes. A relatively dust free environment should be provided during rotational coating. Any air bubbles incurred as a result of pouring can usually be dissipated with a propane torch or hot air stream. Rotation is also a method of containment to reduce gravitational draining of the surface porosity.

Gravitational draining of the surface porosity can also be somewhat inhibited by submerging vessel impregnated porous stones(22) in a non-reactive, non-miscible liquid of a specific gravity of the fluid polymer impregnant composition(23). Submersion is also beneficial to prevent adverse reactions with air during curing of certain polymer forming impregnant compositions(23).

Immersion also works well for solidifying or curing aggregate size products. Light stirring will help prevent individual aggregates from adhering together. Groups of individual aggregates can also be cured or solidified and generally be kept from adhering to each other by a light reciprocating orbital movement of a flat screen bottomed enclosure. A partially filled rotating screened drum also will work for this purpose. Any method normally used for coating groups of small materials can usually be employed to help contain the fluid impregnant(23) during solidification and curing. In many cases, well drained and rinsed aggregate particle can be bulk cured or solidified, and the mass later can be easily separated by light pressure.

Some shrinkage of the impregnant composition(23) may occur during solidification or curing of both mold contained and uncontained articles. This does not appear to be a negative factor, and in some instances, may actually contribute to a stronger article of manufacture due to internal forces imposed upon the porous stone framework(1). Shrinkage cracks can also be a highly decorative factor if they occur in abundance.

Curing or solidification in some mold contained impregnated porous stones(22) may be accomplished by pressure in order to reduce shrinkage and to contain any minor gaseous reaction by-products. Containment molds(25) may be removed when solidification or curing is sufficient enough to allow removal without disturbing the molded surface of an impregnated pre-formed porous stone article.

Step 7. Exposing the Internal Composite Structure

In certain preferred articles of manufacture it is preferred to expose the internal composite structure (see FIG. 13) of individual or agglomerated polymer impregnated pre-formed porous stones. Generally, this is done by machining the surface of a cured or solidified impregnated article. However, any method of exposure is acceptable including, but not limited to sawing and slicing into smaller articles of manufacture. Exposing the internal structure of polymer impregnated pre-formed porous stone provides unique decorative effects that have never before been fully appreciated. This has been described previously in the preferred article of manufacture.

Any abrasive or cutting action that can be applied to plastic compositions may be used to machine polymer impregnated pre-formed porous stone. Wet or dry methods may be used, but wet methods are preferred to reduce dusting and minimize heat build-up. Because the porous stone framework component(1) is generally harder than the polymer composition component(5), tools of sufficient hardness are preferred. Silicon carbide, tungsten carbide, and diamond work best. Metal working and wood working machinery wood very well.

Grinding, sanding, or planing the surface of a highly open-textured vessel contained impregnated pre-formed porous stone produces a smooth surface with numerous textural depressions. Machining the surface of a mold contained impregnated pre-formed porous stone article produces a smooth surface exhibiting filled textural porosity. In both cases, any existing totally enclosed voids will be exposed. The newly exposed porosity can be left as is or filled during the finishing step.

Many machined surfaces can be polished to a satin or glossy finish depending upon the particular component skeletal framework(1) and polymer composition(5). Polishing compounds that can be easily removed from any exposed porosity are preferred. Surfaces should be thoroughly rinsed between each reduction of grit size. After final buffing, a high pressure water rinse should be used to remove any remaining particles from any exposed porosity.

Step 8. Finishing the Surface

Finishing the surface of polymer impregnated pre-formed porous stone articles is a preferred step in producing a high quality product. Some articles are finished as a result of some of the previous steps. Additional finishing steps enhance the decorative effect and provide for greater diversity.

Pore filling or sealing of any surface exposed blind voids(3), shrinkage cracks or occasional air bubbles can be accomplished by traditional methods common to the prior arts of stone or wood finishing. Any moisture incurred during machining should be dehydrated prior to sealing or pore filling. Sealing of exposed porosity on a polished exposed surface can easily be done by wiping with a diluted varnish, oil finish, or wax, and the buffing to remove the excess from the polished surface. Solvents in the sealer should be chosen so that they will not affect the solidified or cured polymer composition(5).

Pore filling or sealing may also be accomplished, and is preferred in this invention (see FIG. 14) by a secondary vacuum/pressure impregnation process utilizing vessel containment or mold containment. This is an essential step in this invention, if a clear film coat finish is to be applied over an exposed surface. Otherwise, air in the exposed porosity will cause bubbles in the clear film coating. Polymer forming compositions are preferred. Any polymer forming composition may be used that does not adversely affect the primary polymer composition. Transparent, translucent, or opaque solidified impregnants(21) may be used. After impregnation, the surface may be wiped with an absorbent material to remove excess fluid impregnant prior to curing. After curing, the surface may be sanded and polished, or coated, if desired. Alternatively, the solidified secondary polymer impregnant composition(21) may remain on the surface as a coating.

Light sandblasting can be used to reduce the gloss in textural-porosity that is recessed below the surface plane of machined surfaces. The planar surface can then be sanded and polished to a desired sheen, for a more attractive overall appearance.

Any additional finishing operations can be accomplished as are ordinarily used in the prior arts of plastics finishing, wood finishing, and stone finishing. They may include, but are not limited to: sandblasting, engraving, chemical etching, painting, stenciling, printing, laminating, film coating, polishing, and waxing.

### CONCLUSION AND SCOPE

The foregoing specification of the preferred embodiments, variations, and specific uses of this invention has been presented for the purpose of illustration and description. It is not meant to limit the invention to the precise forms and methods disclosed. Many further variations exist within the scope of this invention especially in regards to the choice of impregnating fluids, additives or modifiers, porous bodies, methods of production, equipment, and product usage.

The new use of a single labyrinthic bulk filler impregnated in a consistent manner throughout by its containment matrix is the core of this invention. Any article produced in this manner and resembling a natural rock is the result of this new use. Therefore, any such article is included as a variation of this new use.

Accordingly, the scope of this invention should be determined by the appended claims and their legal equivalents.

I claim:

1. A double matrix polymer impregnated stone product suitable for further manufacture comprising:
(a) a stonelike matrix for containing a solidified polymeric matrix, said stonelike matrix being of relatively low compressive strength and relatively low tensile strength, said stonelike matrix being a previously formed to size and external shape skeletal framework of a porous body; and
(b) said solidified polymeric matrix for containing said stonelike matrix, said polymeric matrix being formed to size and shape from a fluid impregnant being solidified within the evacuated permeable interstitial spaces of said porous body and upon the surface of said stonelike matrix, said permeable spaces including a plurality of continuous voids that open to more than one location at the periphery of said porous body, and from said fluid impregnant being distributed in a relatively substantial and consistent manner throughout most of the volume of said evacuated spaces that are capable of said distribution prior to said solidification; and
(c) said stonelike matrix simultaneously being a substantially continuous, three dimensional, interconnected, labyrinthic, stonelike bulk filler for adorning said polymeric matrix in a manner simulative of natural mineral markings being exhibited throughout any substantial cross section of said polymer impregnated stone product; and
(d) said stonelike matrix and said polymeric matrix mutually interlocked in a manner simulative of a natural rock double matrix structure being exhibited throughout said cross section; and
(e) said polymeric matrix simultaneously being a substantially continuous, three dimensional, interconnected, substantially solid, molded void filling for structurally reinforcing said stonelike matrix in a manner simulative of a natural rock void filling being exhibited throughout said cross section, whereby a polymer component is decoratively enhanced by a porous body framework, and a porous body framework is structurally enhanced by a polymer component.

2. The double matrix polymer impregnated stone product of claim 1 further including a plurality of dispersed voids.

3. The double matrix polymer impregnated stone product of claim 1 further including a previously applied treatment coating in contact with said stonelike matrix in a relatively consistent manner.

4. The double matrix polymer impregnated stone product of claim 3 wherein said treatment coating comprises a structural material selected from the group consisting of: priming agents, coupling agents, and thermal expansion agents.

5. The double matrix polymer impregnated stone product of claim 1 wherein said porous body is a porous sedimentary rock selected from the class consisting of: tufa, coquina, coralstone, and sandstone.

6. The double matrix polymer impregnated stone product of claim 1 wherein said porous body is a porous volcanic rock selected from the class consisting of: pumice, scoria, and tuff.

7. The double matrix polymer impregnated stone product of claim 1 wherein said porous body is synthetically produced artificial tufa.

8. The double matrix polymer impregnated stone product of claim 1 wherein said porous body is an artificially made aggregated composition, said aggregated composition being constructed by coating individual particles with a connective means, and then adhering said coated particles in a predetermined arrangement to allow void spaces between most of said coated particles.

9. The double matrix polymer impregnated stone product of claim 1 wherein said polymeric matrix comprises a polymer composition including a polymer selected from the group consisting of: cured resins, thermoplastics hardened from a molten state, and any combination thereof.

10. The double matrix polymer impregnated stone product of claim 1 wherein said fluid impregnant contains an additive selected from the group consisting of dyes, pigments, powdered metals, fillers, extenders, reactive diluents, plasticizers, ultraviolet absorbers, degradation stabilizers, flame retardants, oils, cross linking solvents, coupling agents, and any combination thereof.

11. The double matrix polymer impregnated stone product of claim 1 wherein said permeable interstitial spaces comprise about 20 to 80 volume percent of said porous body.

12. A method for forming a polymeric matrix stone product resembling a natural rock in texture, structure, and formation, said polymeric matrix stone product including a singular, substantially continuous, three dimensional, interconnected, labyrinthic, stonelike bulk filler for defining the size, external shape, and texture of said product, said bulk filler being previously formed to the approximate size and external shape of said product, said bulk filler being a skeletal framework of a porous body, and said product further including a solidified polymeric matrix for coating and supporting said bulk filler, said bulk filler being of relatively low compressive strength and relatively low tensile strength, comprising:
(a) solidifying a fluid impregnant within the evacuated permeable interstitial spaces of said porous body and upon the surface of said bulk filler, said permeable spaces including a plurality of continuous voids that open to more than one location at the periphery of said porous body; and
(b) distributing a fluid impregnant in a relatively substantial and consistent manner throughout most of the volume of said evacuated spaces that are capable of said distribution prior to said solidification, whereby the new use of embedding a single filler of predetermined configuration within a matrix is provided as an advantageous alternative to mixing a multiple particulate filler within a polymer composition matrix.

13. The method of claim 12 is further including preforming said porous body into the size and shape of said stonelike bulk filler.

14. The method of claim 12 wherein said distributing comprises submerging said porous body within said fluid impregnant during said distribution.

15. The method of claim 14 wherein said distributing further includes subjecting said fluid impregnant to a penetration force approaching negative atmospheric pressure during said submergence.

16. The method of claim 15 wherein said distributing further includes subjecting said fluid impregnant to a penetration force exceeding positive atmospheric pressure during said submergence.

17. The method of claim 16 wherein said distributing further includes draining of said fluid impregnant from any size range of said permeable void spaces prior to said solidification, and depositing said fluid impregnant upon most of the interior walls adjacent to said size range of said spaces of said stonelike bulk filler prior to said solidification; wherein said solidified matrix is in contact with said interior walls.

18. The method of claim 12 wherein said solidifying comprises a method of hardening selected from the group consisting of: curing by chemical reaction, cooling from a molten state, and compatible combinations thereof.

19. The method of claim 12 wherein said porous body is a naturally occurring porous rock or mineral.

20. The method of claim 12 wherein said porous body is an artificially constructed or synthesized porous stone that somewhat resembles the structure of a natural porous rock or mineral.

21. The method of claim 12 wherein said fluid impregnant comprises a relatively high concentration of a relatively low viscosity fluid selected from the group consisting of: polymerizable liquids, polymerizable solids that can be made liquid, molten thermoplastic polymers, and compatible combinations thereof.

22. A polymeric matrix stone product when made by the method of claim 21.

23. The method of claim 21 further including dissolving said low viscosity fluid in a relatively low viscosity volatile solvent prior to said distribution.

24. The method of claim 23 further including volatizing most of said solvent prior to said solidification.

25. A polymeric matrix stone product when made by the method of claim 24.

26. A solid surface article suitable for ornamental and architectural use comprising:
(1) at least one external surface for exhibiting the texture of a double matrix internal structure, said external surface comprising:
(a) a solidified synthetic resin matrix being formed from a fluid impregnant being solidified upon the surface of a stonelike matrix, and
(b) a predominant porosity selected from the group consisting of: substantially filled porosity, partially filled porosity and substantially unfilled porosity; and
(2) said double matrix internal structure for defining said predominant porosity of said external surface, said double matrix internal structure comprising:
(a) said stonelike matrix for containing said solidified synthetic resin matrix, said stone matrix being of relatively low compressive strength and relatively low tensile strength, said stonelike matrix being a previously formed to size and external shape skeletal framework of a porous body, and
(b) said solidified synthetic resin matrix being formed to size and shape from a fluid impregnant being solidified within the evacuated permeable interstitial spaces of said porous body, said permeable spaces including a plurality of continuous voids that open to more than one location at the periphery of said porous body, and from said fluid impregnant being distributed in a relatively substantial and consistent manner throughout most of the volume of said evacuated spaces that are capable of said distribution prior to said solidification, and
(c) said stonelike matrix simultaneously being a substantially continuous, three dimensional, interconnected, labyrinthic, stonelike bulk filler for adorning said synthetic resin matrix in a manner simulative of natural mineral markings being exhibited throughout any substantial cross section of said double matrix internal structure, and
(d) said stonelike matrix and said synthetic resin matrix mutually interlocked in a manner simulative of a natural rock double matrix structure being exhibited throughout said cross section, and
(e) said synthetic resin matrix simultaneously being a substantially continuous, three dimensional, interconnected, substantially solid, molded void filling for structurally reinforcing said stonelike matrix in a manner simulative of a natural rock void filling being exhibited throughout said cross section whereby a durable article bearing a striking resemblance to the texture, structure, and formation of a wide range natural rocks is provided.

27. The solid surface article of claim 26, wherein said double matrix internal structure is further exposed to view by any method.

28. The solid surface article of claim 26 wherein said external surface is further finished by any method.

29. The solid surface article of claim 26 further including a plurality of dispersed voids.

30. The solid surface article of claim 26 further including a previously applied treatment coating in contact with said stonelike matrix in a relatively consistent manner.

31. The solid surface article of claim 26 wherein said porous rock is a sedimentary rock selected from the class consisting of: tufa, coquina, coralstone, and sandstone.

32. The solid surface article of claim 26 wherein said porous body is a volcanic rock selected from the class consisting of: pumice, scoria, and tuff.

33. The solid surface article of claim 26 wherein said porous body is synthetically produced tufa.

34. The solid surface article of claim 26 wherein said porous body is an artificial aggregated composition, said aggregated composition being constructed by coating individual particles with a connective means, and then adhering said coated particles in a predetermined arrangement to allow void spaces between most of said coated particles.

35. The solid surface article of claim 26 wherein said solidified synthetic resin matrix comprises a synthetic resin composition including a synthetic resin selected from the group consisting of: epoxy resins, acrylic resins, polyester resins, vinyl resins, allyl resins, polystyrene resins, acronitrile resins, butadiene resins, silicone resins, polyurethane resins, phenolitic resins, nylon resins, mineral resins, and any combination thereof.

36. The solid surface article of claim 26 wherein said permeable interstitial spaces comprise about 20 to 80 volume percent of said porous body.

37. The solid surface article of claim 26 is further including any other material bonded to said double matrix internal structure by connecting said fluid impregnant to said other material prior to said solidification, wherein said solidified synthetic resin being bonded to said other material by a method of adhering is selected from the group consisting of: mechanical bonding and chemical bonding.
